(19) United States
(12) Patent Application Publication
(10) Pub. No.: US 2023/0068653 A1
(43) Pub. Date: Mar. 2, 2023

(54) METHOD AND APPARATUS FOR CONTROLLING VIRTUAL OBJECT TO USE VIRTUAL PROP, TERMINAL, AND MEDIUM

(71) Applicant: Tencent Technology (Shenzhen) Company Limited, Shenzhen (CN)

(72) Inventors: Li YAO, Shenzhen (CN); Zhihong LIU, Shenzhen (CN)

(21) Appl. No.: 17/984,114

(22) Filed: Nov. 9, 2022

Related U.S. Application Data
(63) Continuation of application No. PCT/CN2021/116014, filed on Sep. 1, 2021.

(30) Foreign Application Priority Data
Sep. 17, 2020 (CN) 202010983118.6

(51) Int. Cl. A63F 13/56; A63F 13/52

(52) U.S. Cl. CPC A63F 13/56; A63F 13/52

(57) ABSTRACT

This application discloses a method for controlling a virtual object to use a virtual prop in a virtual environment. The method includes: displaying a throwing route setting control in response to a trigger operation on a target prop control, the target prop control being a use control corresponding to an airdrop virtual prop, the throwing route setting control displaying a virtual environment map; displaying a target throwing route corresponding to the airdrop virtual prop in the virtual environment map in response to a gesture operation on the throwing route setting control, the gesture operation generating the target throwing route passing through a first operation position and a second operation position; and displaying the airdrop virtual prop thrown along the target throwing route. A throwing range of a virtual prop is expanded along the target throwing route, thereby improving a hit ratio of the virtual prop onto another virtual object.

### CROSS-REFERENCE TO RELATED APPLICATIONS

This application is a continuation application of PCT Patent Application No. PCT/CN2021/116014, entitled “METHOD AND APPARATUS FOR CONTROLLING VIRTUAL OBJECT TO USE VIRTUAL PROP, AND TERMINAL AND MEDIUM” filed on Sep. 1, 2021, which claims priority to Chinese Patent Application No. 202010983118.6, filed with the State Intellectual Property Office of the People's Republic of China on Sep. 17, 2020, and entitled “METHOD AND APPARATUS FOR CONTROLLING VIRTUAL OBJECT TO USE VIRTUAL PROP, TERMINAL, AND MEDIUM”, all of which are incorporated herein by reference in their entirety.

### FIELD OF THE TECHNOLOGY

Embodiments of this application relate to the field of virtual scene technologies, and in particular, to a method and an apparatus for controlling a virtual object to use a virtual prop, a terminal, and a medium.

### BACKGROUND OF THE DISCLOSURE

A first person shooting (FPS) game is an application based on a three-dimensional virtual environment, a user may operate a virtual object in a virtual environment to perform motions such as walking, running, climbing, and shooting, and a plurality of users may team up online to complete a task in the same virtual environment.

In the related art, a virtual object may be pre-equipped with a throwing virtual prop (for example, a grenade) before a battle is started, and the user may control the virtual object to use the throwing virtual prop to a target use object. A process in which the user controls the virtual object to cause damage is as follows: clicking/tapping a virtual prop control, determining a throwing position, and controlling the virtual object to throwing the virtual prop to the throwing position.

However, the virtual object needs to be controlled to throw the throwing virtual prop provided in the related art, the throwing virtual prop can be thrown to only one fixed-point position during each throwing, and there is a specific time interval between the throwing virtual prop and a landing position. In addition, due to a fixed-point use manner of the throwing virtual prop, an action range of the throwing virtual prop is relatively small, making the action range easy to be found and avoided, resulting in a relatively low hit ratio of the throwing virtual prop.

### SUMMARY

Embodiments of this application provide a method and an apparatus for controlling a virtual object to use a virtual prop, a terminal, and a medium, which can enrich types of virtual props and change attribute values of virtual objects in a target throwing route by using the virtual prop, to improve a hit ratio of the virtual prop. The technical solutions are as follows.

According to an aspect, the embodiments of this application provide a method for controlling a virtual object to use a virtual prop performed by a terminal, the method including:

displaying a throwing route setting control in response to a trigger operation on a target prop control, the target prop control being a use control corresponding to an airdrop virtual prop, the throwing route setting control displaying a virtual environment map;

displaying a target throwing route corresponding to the airdrop virtual prop in the virtual environment map in response to a gesture operation on the throwing route setting control, the gesture operation including determining (e.g., dragging) a first operation position and a second operation position on the virtual environment map, the target throwing route passing through the first operation position and the second operation position; and

displaying the airdrop virtual prop thrown along the target throwing route in a virtual environment, the airdrop virtual prop being used for changing attribute values of virtual objects.

According to another aspect, the embodiments of this application provide an apparatus for controlling a virtual object to use a virtual prop, including:

a first display module, configured to display a throwing route setting control in response to a trigger operation on a target prop control, the target prop control being a use control corresponding to an airdrop virtual prop, the throwing route setting control displaying a virtual environment map;

a second display module, configured to display a target throwing route corresponding to the airdrop virtual prop in the virtual environment map in response to a gesture operation on the throwing route setting control, the gesture operation including determining (e.g., dragging) a first operation position and a second operation position on the virtual environment map, the target throwing route passing through the first operation position and the second operation position; and

a third display module, configured to display the airdrop virtual prop thrown along the target throwing route in a virtual environment, the airdrop virtual prop being used for changing attribute values of virtual objects.

According to another aspect, the embodiments of this application provide a terminal, including a processor and a memory, the memory storing at least one program, the at least one program being loaded and executed by the processor and causing the terminal to implement the method for controlling a virtual object to use a virtual prop described in the foregoing aspect.

According to another aspect, embodiments of this application provide a non-transitory computer-readable storage medium, storing at least one program, the at least one program being loaded and executed by a processor of a terminal and causing the terminal to implement the method for controlling a virtual object to use a virtual prop described in the foregoing aspect.

According to another aspect, the embodiments of this application provide a computer program product or a computer program, the computer program product or the computer program including computer instructions, the computer instructions being stored in a non-transitory computer-readable storage medium. A processor of a terminal reads the computer instructions from the non-transitory computer-readable storage medium, and executes the computer instructions, to cause the terminal to perform the method for controlling a virtual object to use a virtual prop provided in the optional implementations of the foregoing aspect.

The technical solutions provided in the embodiments of this application have at least the following beneficial effects:

In the embodiments of this application, an airdrop virtual prop is introduced into a virtual prop, and a user may plan a throwing route in a virtual environment map by using a gesture operation, so that the airdrop virtual prop may be thrown along a target throwing route. Compared with the related art in which a virtual prop can be only thrown at a fixed point, in the embodiments of this application, the airdrop virtual prop may be thrown along a specified route. On one hand, a throwing range of the virtual prop is expanded, so that the throwing range of the virtual prop is not easy to be avoided by another virtual object, thereby improving a hit ratio of the virtual prop. On the other hand, when some virtual objects adopt a squatting or remote attack policy, the virtual objects may be attacked remotely in a large range by using the airdrop virtual prop, to improve a hit ratio for the virtual objects, thereby accelerating a battle process, effectively controlling a duration of a single round, and further reducing processing pressure of a server.

### BRIEF DESCRIPTION OF THE DRAWINGS

FIG. 1 shows a schematic architectural diagram of a computer system according to an embodiment of this application.

FIG. 2 is a flowchart of a method for controlling a virtual object to use a virtual prop according to an exemplary embodiment of this application.

FIG. 3 is a schematic diagram of a process of controlling a virtual object to use a virtual prop according to an exemplary embodiment of this application.

FIG. 4 is a schematic diagram of a process of determining a target throwing route according to a first operation position and a second operation position.

FIG. 5 is a flowchart of a method for controlling a virtual object to use a virtual prop according to another exemplary embodiment of this application.

FIG. 6 is a schematic diagram of a prop equipment interface of an airdrop virtual prop according to an exemplary embodiment of this application.

FIG. 7 is a flowchart of a method for controlling a virtual object to use a virtual prop according to another exemplary embodiment of this application.

FIG. 8 is a schematic diagram of a process of displaying a position of a virtual object according to an exemplary embodiment of this application.

FIG. 9 is a flowchart of a method for controlling a virtual object to use a virtual prop according to another exemplary embodiment of this application.

FIG. 10 is a schematic diagram of throwing an airdrop virtual prop in a virtual environment according to a preset throwing distance and a target throwing route according to an exemplary embodiment of this application.

FIG. 11 is a schematic diagram of throwing an airdrop virtual prop in a virtual environment according to a preset thrown quantity and a target throwing route according to an exemplary embodiment of this application.

FIG. 12 is a flowchart of a method for controlling a virtual object to use a virtual prop according to another exemplary embodiment of this application.

FIG. 13 is a schematic diagram of a process of throwing an airdrop virtual prop according to an exemplary embodiment of this application.

FIG. 14 is a flowchart of a method for controlling a virtual object to use a virtual prop according to another exemplary embodiment of this application.

FIG. 15 is a structural block diagram of an apparatus for controlling a virtual object to use a virtual prop according to an exemplary embodiment of this application.

FIG. 16 is a structural block diagram of a terminal according to an exemplary embodiment of this application.

### DESCRIPTION OF EMBODIMENTS

To make objectives, technical solutions, and advantages of this application clearer, the following further describes implementations of this application in detail with reference to the accompanying drawings.

First, terms involved in the embodiments of this application are introduced:

A virtual environment is a virtual environment displayed (or provided) by an application when run on a terminal. The virtual environment may be a simulated environment of a real world, or may be a semi-simulated semi-fictional environment, or may be an entirely fictional environment. The virtual environment may be any one of a two-dimensional virtual environment, a 2.5-dimensional virtual environment, and a three-dimensional virtual environment. This is not limited in this application. In the embodiments, a description is made by using an example in which the virtual environment is a three-dimensional virtual environment.

Virtual object is a movable object in a virtual environment. The movable object may be a virtual character, a virtual animal, a cartoon character, or the like, such as a character or an animal displayed in a three-dimensional virtual environment. In some embodiments, the virtual object is a three-dimensional model created based on a skeletal animation technology. Each virtual object has a respective shape and size in the three-dimensional virtual environment, and occupies some space in the three-dimensional virtual environment.

Shooter game includes a first-person shooter (FPS) game and a third-person shooter (TPS) game. The FPS game is a shooting game in which a user can play from a first-person perspective. A virtual environment picture in the game is a picture of observing a virtual environment from the perspective of a first virtual object. The TPS game is a shooting game playing from a third-person perspective. A virtual environment picture in the game is a picture of observing a virtual environment from the third-person perspective (for example, located behind the head of a first virtual object).

In the game, at least two virtual objects play in a single-round battle mode in the virtual environment. The virtual object escapes damages by other virtual objects and dangers (such as a poison gas area and a swamp) in the virtual environment to survive in the virtual environment. When a health value of the virtual object in the virtual environment is zero, the life of the virtual object in the virtual environment ends, and the final virtual object surviving in the virtual environment wins. In some embodiments, a battle starts with a moment when a first client joins the battle, and ends with a moment when the last client exits the battle. Each client may control one or more virtual objects in the virtual environment. In some embodiments, arena modes of the battle may include a single-player battle mode, a two-player team battle mode, or a multi-player team battle mode. The battle mode is not limited in the embodiments of this application.

Virtual prop: It is a prop that a virtual object can use in a virtual environment, including a virtual weapon that can change an attribute value of another virtual object, a supply prop such as bullets, a defensive prop such as a shield, an armor, or an armored vehicle, a virtual prop such as a virtual beam or a virtual shock wave shown through a hand when being used for casting a skill by the virtual object, and a body part of the virtual object, such as a hand or a leg. The virtual prop that can change the attribute value of another virtual object includes a long-distance virtual prop such as a pistol, a rifle, or a sniper rifle, a short-distance virtual prop such as a dagger, a sword, a knife, or a rope, and a throwing virtual prop such as a throwing ax, a throwing knife, a grenade, a flashbomb, or a smoke bomb.

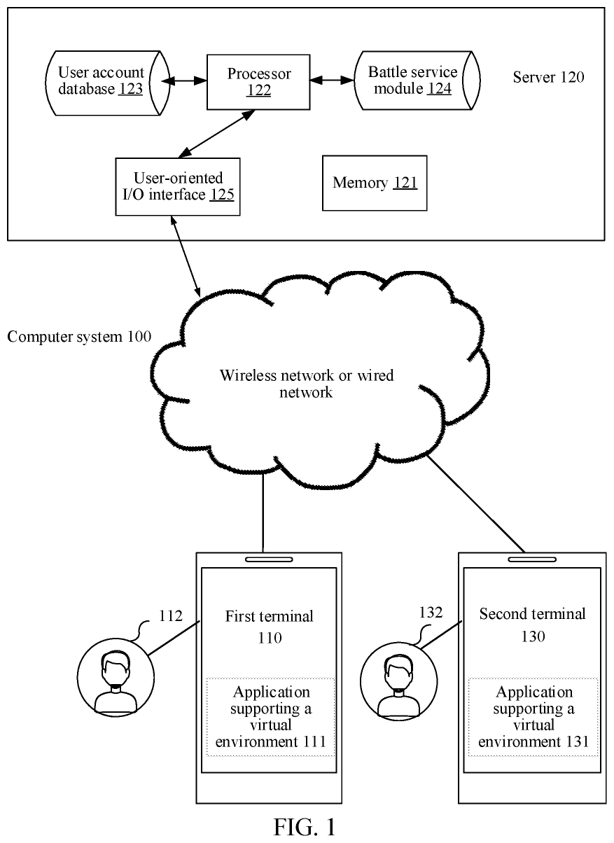

FIG. 1 shows a schematic architectural diagram of a computer system according to an embodiment of this application. The computer system may include a first terminal 110, a server 120, and a second terminal 130.

An application 111 supporting a virtual environment is run on the first terminal 110, and the application 111 may be a multiplayer online battle program. When the first terminal runs the application 111, a user interface of the application 111 is displayed on a screen of the first terminal 110. The application 111 may be any one of a multiplayer online battle arena (MOBA) game, a battle royale shooting game, or a simulation game (SLG). In this embodiment, an example in which the application 111 is an FPS game is used for description. The first terminal 110 is a terminal used by a first user 112. The first user 112 uses the first terminal 110 to control a first virtual object located in the virtual environment to perform activities, and the first virtual object may be referred to as a main control virtual object of the first user 112. The activities of the first virtual object include, but are not limited to: at least one of adjusting body postures, crawling, walking, running, riding, flying, jumping, driving, picking, shooting, attacking, throwing, and skill casting. For example, the first virtual object is a first virtual person such as a simulated person or a cartoon person.

An application 131 supporting a virtual environment is run on the second terminal 130, and the application 131 may be a multiplayer online battle program. When the second terminal 130 runs the application 131, a user interface of the application 131 is displayed on a screen of the second terminal 130. The client may be any one of a MOBA game, an escape shooting game, or an SLG game. In this embodiment, an example in which the application 131 is an FPS game is used for description. The second terminal 130 is a terminal used by a second user 132. The second user 132 uses the second terminal 130 to control a second virtual object located in the virtual environment to perform activities, and the second virtual object may be referred to as a main control virtual object of the second user 132. For example, the second virtual object is a second virtual person, such as a simulated person or a cartoon person.

In some embodiments, the first virtual object and the second virtual object are located in the same virtual world. In some embodiments, the first virtual object and the second virtual object may belong to the same camp, the same team, or the same organization, have a friend relationship with each other, or have a temporary communication permission. In some embodiments, the first virtual object and the second virtual object may belong to different camps, different teams, or different organizations, or have a hostile relationship with each other.

In some embodiments, the applications run on the first terminal 110 and the second terminal 130 are the same, or the applications run on the two terminals are the same type of applications on different operating system platforms (Android system or iOS system). The first terminal 110 may generally refer to one of a plurality of terminals, and the second terminal 130 may generally refer to another one of a plurality of terminals. In this embodiment, only the first terminal 110 and the second terminal 130 are used as an example for description. Device types of the first terminal 110 and the second terminal 130 are the same or different. The device type includes at least one of a smartphone, a tablet computer, an e-book reader, a Moving Picture Experts Group Audio Layer III (MP3) player, a Moving Picture Experts Group Audio Layer IV (MP4) player, a laptop computer, and a desktop computer.

FIG. 1 shows only two terminals. However, a plurality of other terminals may access the server 120 in different embodiments. In some embodiments, one or more terminals are terminals corresponding to a developer. A developing and editing platform for the application supporting a virtual environment is installed on the terminal. The developer may edit and update the application on the terminal and transmit an updated application installation package to the server 120 by using a wired or wireless network. The first terminal 110 and the second terminal 130 may download the application installation package from the server 120 to update the application.

The first terminal 110, the second terminal 130, and the another terminal are connected to the server 120 through a wireless network or a wired network.

The server 120 includes at least one of one server, a server cluster including a plurality of servers, a cloud computing platform, and a virtualization center. The server 120 is configured to provide a backend service for an application supporting a three-dimensional virtual environment. In some embodiments, the server 120 is responsible for primary computing work, and the terminal is responsible for secondary computing work; or the server 120 is responsible for secondary computing work, and the terminal is responsible for primary computing work; or the server 120 and the terminal perform collaborative computing by using a distributed computing architecture between each other.

In a schematic example, the server 120 includes a memory 121, a processor 122, a user account database 123, a battle service module 124, and a user-oriented input/output (I/O) interface 125. The processor 122 is configured to load instructions stored in the server 120, and process data in the user account database 123 and the battle service module 124. The user account database 123 is configured to store data of user accounts used by the first terminal 110, the second terminal 130, and the another terminal, for example, avatars of the user accounts, nicknames of the user accounts, battle effectiveness indexes of the user accounts, and service zones of the user accounts. The battle service module 124 is configured to provide a plurality of battle rooms for the users to battle, for example, a 1V1 battle room, a 3V3 battle room, a 5V5 battle room, and the like. The user-oriented I/O interface 125 is configured to establish communication between the first terminal 110 and/or the second terminal 130 by using a wireless network or a wired network for data exchange.

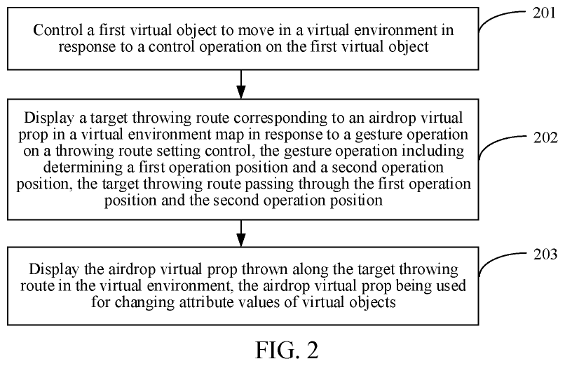

FIG. 2 is a flowchart of a method for controlling a virtual object to use a virtual prop according to an exemplary embodiment of this application. This embodiment is described by using an example in which the method is applied to the first terminal 110 or the second terminal 130 in the implementation environment shown in FIG. 1 or another terminal in the implementation environment. The method includes the following steps:

Step 201. Display a throwing route setting control in response to a trigger operation on a target prop control, the target prop control being a use control corresponding to an airdrop virtual prop, the throwing route setting control displaying a virtual environment map.

The airdrop virtual prop indicates a virtual prop that may perform an attack along a preset throwing route, and the preset throwing route is determined by a user through a gesture operation.

In one implementation, after a virtual object is equipped with the airdrop virtual prop and enters a battle, a target prop control corresponding to the airdrop virtual prop is displayed in a user interface, and the user may control the virtual object to use the airdrop virtual prop by triggering the target prop control.

In this embodiment of this application, the method is applicable to a virtual environment. The virtual environment includes a first virtual object and a second virtual object, and the first virtual object and the second virtual object belong to different camps. In one implementation, a terminal displays the virtual environment through a virtual environment picture. In some embodiments, the virtual environment picture is a picture of observing the virtual environment from the perspective of the virtual object. The perspective is an observation angle for observation from a first-person perspective or a third-person perspective of the virtual object in the virtual environment. In some embodiments, in this embodiment of this application, the perspective is an angle for observing the virtual object by using a camera model in the virtual environment.

In some embodiments, the camera model automatically follows the virtual object in the virtual environment. That is, when a position of the virtual object in the virtual environment changes, a position of the camera model following the virtual object in the virtual environment changes simultaneously, and the camera model is always within a preset distance range from the virtual object in the virtual environment. In some embodiments, in the automatic following process, relative positions of the camera model and the virtual object remain unchanged.

The camera model is a three-dimensional model around the virtual object in the virtual environment. When a first-person perspective is adopted, the camera model is located near the head of the virtual object or at the head of the virtual object. When a third-person viewing angle is used, the camera model may be located behind the virtual object and bound to the virtual object, or may be located at any position away from the virtual object by a preset distance. The virtual object located in the virtual environment may be observed from different angles through the camera model. When the third-person perspective is a first-person over-shoulder perspective, the camera model is located behind the virtual object (for example, the head and the shoulders of a virtual person). In some embodiments, in addition to the first-person perspective and the third-person perspective, the perspective further includes another perspective such as a look-down perspective. When the look-down perspective is used, the camera model may be located above the head of the virtual object. The look-down perspective is a perspective for observing the virtual environment at an angle from the air. In some embodiments, the camera model is not actually displayed in the virtual environment. In other words, the camera model is not displayed in the virtual environment displayed in the user interface.

A description is made by using an example in which the camera model is located at any position at a preset distance from the virtual object. In some embodiments, one virtual object corresponds to one camera model, and the camera model may rotate with the virtual object as a rotation center. For example, the camera model is rotated with any point of the virtual object as the rotation center. During rotation, the camera model is not only rotated, but also displaced. During rotation, a distance between the camera model and the rotation center remains unchanged, that is, the camera model is rotated on a surface of a sphere with the rotation center as a sphere center. Any point of the virtual object may be the head or the torso of the virtual object, or any point around the virtual object. This is not limited in this embodiment of this application. In some embodiments, when the camera model observes the virtual object, a center of the perspective of the camera model points to a direction from a point on the spherical surface at which the camera model is located to the sphere center.

In some embodiments, the camera model may alternatively observe the virtual object at a preset angle in different directions of the virtual object. In some embodiments, the first virtual object is a virtual object controlled by the user through the terminal, the second virtual object includes at least one of a virtual object controlled by another user or a virtual object controlled by a backend server, and the first virtual object and the second virtual object belong to different camps.

Different from a fixed-point throwing manner in the related art, the airdrop virtual prop provided in this embodiment of this application may be continuously thrown along a specified route. Therefore, in a possible implementation, when receiving a trigger operation on the target prop control, the terminal displays a throwing route setting control on a current user interface, and displays a virtual environment map by using the throwing route setting control, so that the user sets a target throwing route of the airdrop virtual prop in the virtual environment map.

The trigger operation on the target prop control by the user may be a click/tap operation, a touch and hold operation, a double-click/tap operation, or the like. This is not limited in this embodiment of this application.

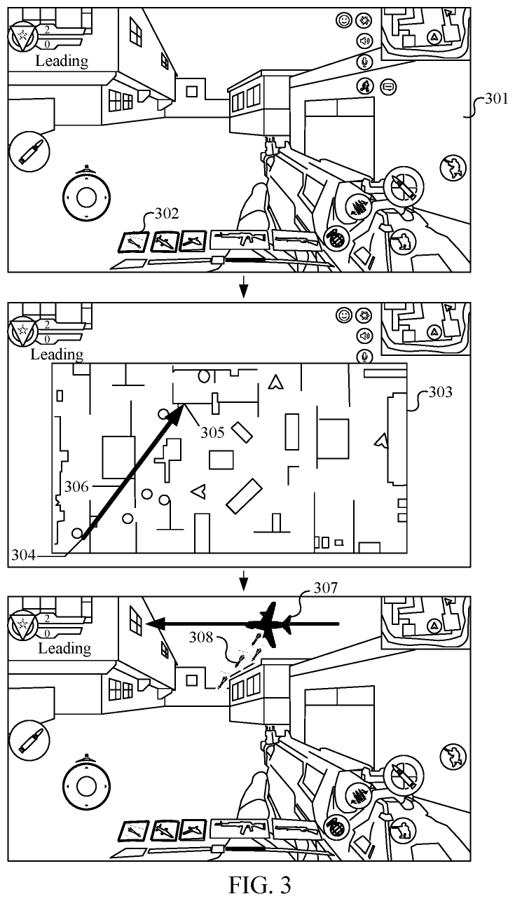

FIG. 3 is a schematic diagram of a process of controlling a virtual object to use a virtual prop according to an exemplary embodiment of this application. After a battle is entered, a virtual environment picture 301 and a target prop control 302 are displayed in a user interface. After a user clicks/taps the target prop control 302, the terminal receives a trigger operation on the target prop control 302 and displays a throwing route setting control 303 on the current user interface, the throwing route setting control 303 being used for displaying a virtual environment map. In some embodiments, a virtual object identifier is displayed in the virtual environment map.

Step 202. Display a target throwing route corresponding to the airdrop virtual prop in the virtual environment map in response to a gesture operation on the throwing route setting control, the gesture operation including determining a first operation position and a second operation position, the target throwing route passing through the first operation position and the second operation position.

The gesture operation may be a single-finger sliding operation, a double-finger sliding operation, a double-finger click/tap operation, a double-finder touch and hold operation on a touch screen, an input using a mouse or joystick or the like. Only two operation positions need to be determined according to the gesture operation, and a type of the gesture operation is not limited in this embodiment of this application.

In one implementation, the user needs to perform the gesture operation on the throwing route setting control in which the virtual environment map is displayed, and the corresponding terminal receives the gesture operation on the throwing route setting control and determines a first operation position and a second operation position on which the gesture operation acts, that is, may determine a target throwing route according to the first operation position and the second operation position.

In some embodiments, the target throwing route indicated by the gesture operation may be displayed in the virtual environment map so that the user may clarify the target throwing route planned by the user. For example, a display form of the target throwing route may be a line segment form, a single-arrow form, or a double-arrow form.

In an exemplary example, as shown in FIG. 3, the single-finger sliding operation is used as an example. When the user performs a sliding operation on the throwing route setting control 303, that is, slides from a first operation position 304 to a second operation position 305, the terminal determines the first operation position 304 and the second operation position 305 and may determine a line segment 306 as a target throwing route.

When the target throwing route is determined according to the first operation position and the second operation position, a route between the first operation position and the second operation position may be directly determined as the target throwing route, or a straight line passing through the first operation position and the second operation position in the virtual environment map may be determined as the target throwing route. This is not limited in this embodiment of this application.

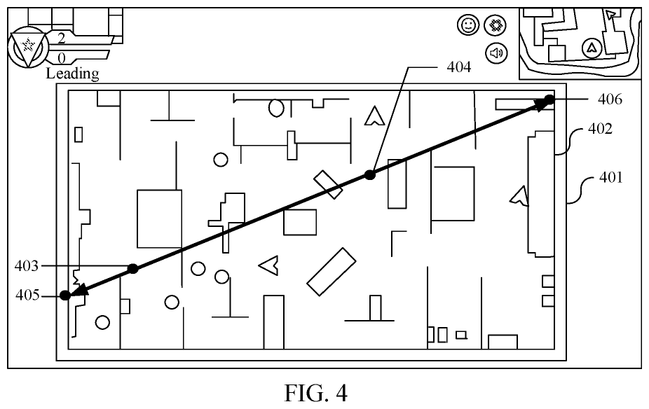

In an exemplary example, FIG. 4 is a schematic diagram of a process of determining a target throwing route according to a first operation position and a second operation position. A virtual environment map 402 is displayed in a throwing route setting control 401. After receiving a gesture operation on the virtual environment map and determining a first operation position 403 and a second operation position 404, the terminal may determine a route between the first operation position 403 and the second operation position 404 as a target throwing route, or determine a route between a position 405 and a position 406 as a target throwing route (the position 405 and the position 406 are positions where a straight line passing through the first operation position 403 and the second operation position 404 interacts with boundaries of the virtual environment map), or determine a route between the first operation position 403 and a position 406 as a target throwing route, or determine a route between the second operation position 404 and a position 405 as a target throwing route. The target throwing route is not limited in this embodiment of this application.

In some embodiments, the terminal may determine at least one candidate throwing route based on the first operation position and the second operation position on which the gesture operation of the user acts, and the user selects the target throwing route from a plurality of candidate throwing routes. For example, in FIG. 4, if the candidate throwing routes determined by the terminal include: from the first operation position 403 to the second operation position 404, from the first operation position 403 to the position 406, from the position 405 to the position 406, and from the position 405 to the second operation position 404, prompt information may be displayed in an upper layer of the current user interface, to prompt the user of selecting the target throwing route from the plurality of candidate throwing routes. In some embodiments, the terminal may display selection controls corresponding to the candidate throwing routes in a prompt box. When receiving a trigger operation on a target selection control, the terminal determines a candidate throwing route corresponding to the target selection control as the target throwing route.

Step 203. Display the airdrop virtual prop thrown along the target throwing route in a virtual environment, the airdrop virtual prop being used for changing attribute values of virtual objects.

In one implementation, after the user plans the target throwing route in the throwing route setting control, the corresponding terminal determines a position of the target throwing route in the virtual environment map, that is, may throw the airdrop virtual prop according to the target throwing route in the virtual environment according to a mapping relationship between positions in the virtual environment map and the virtual environment, the airdrop virtual prop thrown along the target throwing route being displayed in the corresponding virtual environment, and the airdrop virtual prop being used for changing attribute values of virtual objects in the target throwing route.

When the airdrop virtual prop thrown along the target throwing route is displayed in the virtual environment, the target throwing route may not be displayed in the virtual environment. When a throwing position of the airdrop virtual prop is in an actual throwing route corresponding to the target throwing route in the virtual environment, it indicates that the airdrop virtual prop thrown along the target throwing route is displayed in the virtual environment. When a connection line between at least two throwing positions corresponding to the airdrop virtual prop is located in the actual throwing route corresponding to the target throwing route in the virtual environment, it indicates that the airdrop virtual prop thrown along the target throwing route is displayed in the virtual environment.

In some embodiments, after determining the target throwing route, the terminal may alternatively report the target throwing route to a server, and the server throws the airdrop virtual prop in the virtual environment based on the target throwing route, and feeds back throwing information of the airdrop virtual prop to the terminal, so that the terminal may display the airdrop virtual prop thrown along the target throwing route in the virtual environment.

In some embodiments, the terminal and the server may alternatively collaboratively throw the airdrop virtual prop. The terminal reports the target throwing route to the server, and the server verifies the target throwing route and allows the terminal to throw the airdrop virtual prop along the target throwing route after the verification succeeds. Correspondingly, after receiving a verification success instruction, the terminal throws the airdrop virtual prop in the virtual environment based on the target throwing route and feeds back throwing information of the airdrop virtual prop to the server, and the server forwards the throwing information to another terminal.

The attribute values may be a health value, a defense value, an attack power, a speed, and the like of the virtual object.

In some embodiments, a virtual carrier prop may carry the airdrop virtual prop and throw the airdrop virtual prop according to the target throwing route. The virtual carrier prop may be an airplane, a hot air balloon, or the like.

For example, as shown in FIG. 3, after the user determines the target throwing route, the throwing route setting control is folded or disappears. A virtual carrier prop 307 appears in a throwing route starting point of the target throwing route indicated in the virtual environment and throws an airdrop virtual prop 308 along the throwing route.

Based on the foregoing, an airdrop virtual prop is introduced into a virtual prop, and a user may plan a throwing route in a virtual environment map by using a gesture operation, so that the airdrop virtual prop may be thrown along a target throwing route. Compared with the related art in which a virtual prop can be only thrown at a fixed point, in this embodiment of this application, the airdrop virtual prop may be thrown along a specified route. On one hand, a throwing range of the virtual prop is expanded, so that the throwing range of the virtual prop is not easy to be avoided by another virtual object, thereby improving a hit ratio of the virtual prop. On the other hand, when some virtual objects adopt a squatting or remote attack policy, the virtual objects may be attacked remotely in a large range by using the airdrop virtual prop, to improve a hit ratio for the virtual objects, thereby accelerating a battle process, effectively controlling a duration of a single round, and further reducing processing pressure of a server.

The airdrop virtual prop is a continuous killing skill prop, that is, after a continuous killing score (or quantity) of a virtual object reaches a preset score threshold (or a quantity threshold), the airdrop virtual prop may be used. Therefore, after the user equips the virtual object with the airdrop virtual prop and enters a battle, although the target prop control corresponding to the airdrop virtual prop is displayed in the user interface, the target prop control is set to an inactive state (e.g., the target prop control is greyed out and/or cannot be triggered by a user operation), and only after the continuous killing score of the virtual object meets the preset score threshold, the target prop control is in an active state (e.g., the target prop control is highlighted with predefined color and/or can be triggered by a user operation), that is, the virtual object may use the airdrop virtual prop.

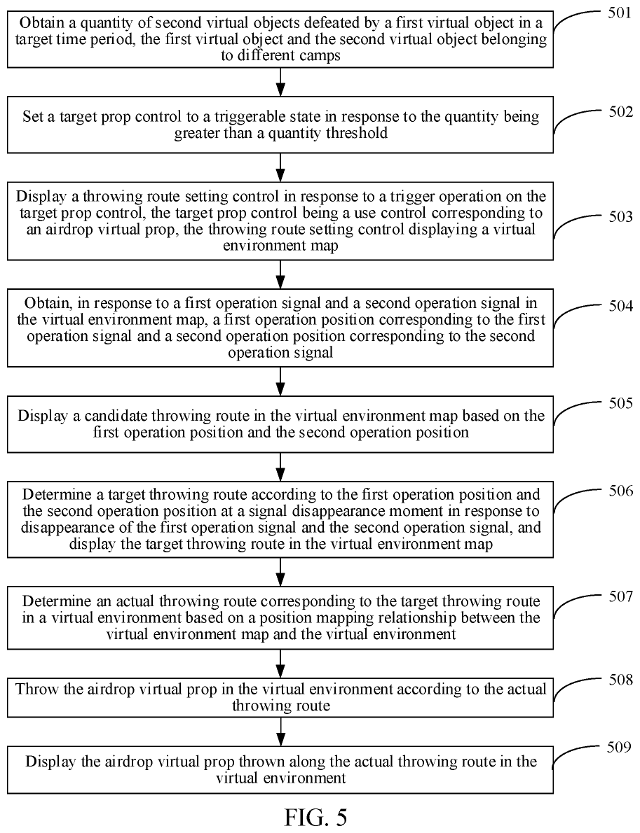

FIG. 5 is a flowchart of a method for controlling a virtual object to use a virtual prop according to another exemplary embodiment of this application. This embodiment is described by using an example in which the method is applied to the first terminal 110 or the second terminal 130 in the implementation environment shown in FIG. 1 or another terminal in the implementation environment. The method includes the following steps.

Step 501. Obtain a quantity of second virtual objects defeated by a first virtual object in a target time period, the first virtual object and the second virtual object belonging to different camps.

In some embodiments, because an airdrop virtual prop may cause damage to virtual objects in a relatively large range and has a relatively large attack power, the airdrop virtual prop is set to a continuous killing skill weapon, a continuous killing skill prop, or a continuous score prop. Correspondingly, the airdrop virtual prop has a use condition, that is, a controlled virtual object needs to meet the use condition before using the airdrop virtual prop.

In some embodiments, based on a prop type to which the airdrop virtual prop belongs, the use condition of the airdrop virtual prop may be that a quantity of second virtual objects defeated by a first virtual object (the controlled virtual object) in a target time period meets a quantity threshold; or a defeating score obtained by a first virtual object defeating a second virtual object in a target time period meets a score threshold.

The target time period may be set by a developer. For example, the target time period may be 10 min, that is, a quantity of second virtual objects defeated by the first virtual object within any continuous 10 min is obtained, and then it is determined whether the quantity of defeated second virtual objects may meet the use condition of the airdrop virtual prop.

In one implementation, before displaying the user interface having the virtual environment picture, the terminal displays a prop equipment interface in advance. In the prop equipment interface, the user may select a virtual prop that needs to be carried in a current battle. In this embodiment of this application, a continuous score prop interface is provided in the prop equipment interface, and at least one continuous score prop is displayed in the continuous score prop interface. The user may enter the battle after selecting an airdrop virtual prop in the continuous score prop interface and clicking/tapping an equipment control, and a target prop control corresponding to the airdrop virtual prop is displayed in the user interface.

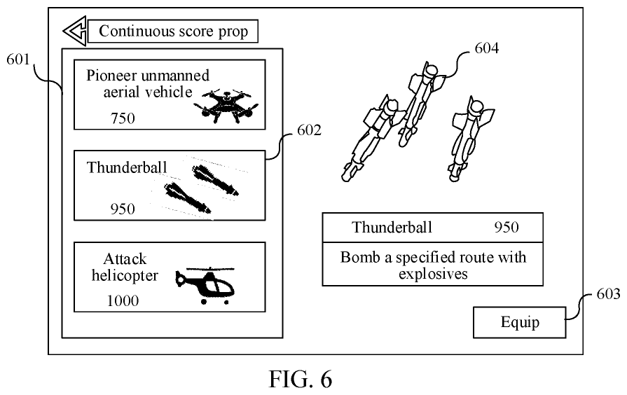

In an exemplary example, FIG. 6 is a schematic diagram of a prop equipment interface of an airdrop virtual prop according to an exemplary embodiment of this application. A prop selection bar 601 is displayed in a continuous score prop interface. The prop selection bar includes a prop selection control 602 corresponding to at least one continuous score prop such as a pioneer unmanned aerial vehicle, a thunderball (that is, the airdrop virtual prop provided in this embodiment of this application), or an attack helicopter, and a use condition (that is, a preset score) of the prop is displayed in each continuous score prop, for example, a preset score corresponding to the pioneer unmanned aerial vehicle is 750, that is, if a virtual object is equipped with the prop, the virtual object may use the prop after a killing score reaches 700. After the user clicks/taps the prop selection control 602 corresponding to the thunderball prop, a prop introduction, that is, a required killing score (950) and a function (bombing a specified route with explosives) that correspond to the thunderball 604, corresponding to the thunderball prop is displayed in the continuous score prop interface. After the user clicks/taps an equipment control 603, it indicates that the virtual object is equipped with the thunderball prop.

The airdrop virtual prop has a specific use condition, that is, after the user needs to control the first virtual object to defeat a specific quantity of second virtual objects in a preset time period after entering a battle, or after a score obtained by defeating the second virtual object reaches a specific value, the target prop control is changed into an active state, that is, the airdrop virtual prop may be used. Therefore, in a possible implementation, after the first virtual object equipped with the airdrop virtual prop enters a battle, the terminal obtains, in real time, a quantity of second virtual objects defeated by the first virtual object or a score obtained by defeating the second virtual object, to determine a setting status of the target prop control.

Step 502. Set the target prop control to an active state in response to the quantity being greater than a quantity threshold.

In some embodiments, different use conditions are set for each continuous score prop, which may be a defeated quantity or may be a defeated score. For example, the use condition corresponding to the airdrop virtual prop may be continuously defeating a specific quantity (reaching the quantity threshold) of virtual objects or obtaining a specific score (reaching the score threshold) by continuously defeating the virtual objects. Therefore, when obtaining the quantity of second virtual objects defeated by the first virtual object, the terminal compares the quantity with the quantity threshold, determines, through a result of comparison, whether the use condition of the airdrop virtual prop is met, and further determines the setting status corresponding to the target prop control based on a condition determining result.

For a use rule of the airdrop virtual prop, when the user controls the first virtual object to just enter a battle or the quantity of second virtual objects defeated by the first virtual object in the target time period is less than the quantity threshold (that is, the use condition corresponding to the airdrop virtual prop is not met), the terminal sets the target prop control to an inactive state until the quantity meets the quantity threshold.

The quantity threshold corresponding to the airdrop virtual prop may be 10, that is, after the first virtual object defeats 10 second virtual objects, the virtual object may use the airdrop virtual prop.

Correspondingly, after determining that the quantity of second virtual objects defeated by the first virtual object reaches or exceeds the quantity threshold, the terminal may set the target prop control to the active state.

The inactive state may be that an icon corresponding to the target prop control is grey or black, and the corresponding triggerable state may be that the icon corresponding to the target prop control is highlighted.

In some embodiments, when controlling the first virtual object to defeat the second virtual object, the user may obtain a specific score, and correspondingly, a score threshold may also be set. The use condition of the airdrop virtual prop is set to that a score obtained by the first virtual object in the target time period is greater than the score threshold. For example, the score threshold may be 900.

In one implementation, after the first virtual object defeats the second virtual object in the battle and an obtained score reaches or exceeds the score threshold, the use condition of the airdrop virtual prop is met, and it indicates that the first virtual object may use the airdrop virtual prop in the battle. That is, when the score obtained by the first virtual object defeating the second virtual object is less than the score threshold, the terminal sets the target prop control corresponding to the airdrop virtual prop to the inactive state. If the score obtained by the first virtual object defeating the second virtual object is greater than the score threshold, the terminal sets the target prop control corresponding to the airdrop virtual prop to the active state.

In some embodiments, considering that it takes a long time for the first virtual object to obtain a specific score by defeating the second virtual object one by one, in another possible implementation, a continuous killing concept is set, that is, when the first virtual object continuously defeats the second virtual object in a pre-determined time, an obtained defeated score is doubled, and a larger quantity of continuously killed second virtual objects indicates more doubled scores. Therefore, the score obtained by the first virtual object may more easily reach the preset score threshold, thereby improving an activation rate of the airdrop virtual prop. The specified time may be 20 minutes.

Step 503. Display a throwing route setting control in response to a trigger operation on a target prop control, the target prop control being a use control corresponding to an airdrop virtual prop, the throwing route setting control displaying a virtual environment map.

For an implementation of step 503, reference may be made to the foregoing embodiments, and details are not described again in this embodiment.

In some embodiments, after the target prop control corresponding to the airdrop virtual prop is triggered, the target prop control is changed from the active state to the inactive state. If the airdrop virtual prop needs to be used again, the use condition corresponding to the airdrop virtual prop needs to be met again.

Step 504. Obtain, in response to a first operation signal and a second operation signal in the virtual environment map, a first operation position corresponding to the first operation signal and a second operation position corresponding to the second operation signal.

To distinguish from a fixed-point throwing manner in the related art, this embodiment of this application provides a dual-contact operation manner, that is, two operation signals may be simultaneously received in a virtual environment map, and the target throwing route is adjusted through rotation or displacement.

When a gesture operation is used as the dual-contact operation manner, the gesture operation may be a double-finger operation or may be another gesture operation that may simultaneously generate two operation signals.

In one implementation, when the user performs a gesture operation on the throwing route setting control, the corresponding terminal receives a first operation signal and a second operation signal in the virtual environment map, that is, obtains a first operation position corresponding to the first operation signal and a second operation position corresponding to the second operation signal, and changes the first operation position and the second operation position by following the first operation signal and the second operation signal in real time.

Step 505. Display a candidate throwing route in the virtual environment map based on the first operation position and the second operation position.

The user cannot immediately determine the target throwing route in the virtual environment map, and the user may adjust the gesture operation in real time, to determine a most suitable target throwing route. Therefore, in a possible implementation, after receiving the gesture operation, the terminal determines a candidate throwing route according to the first operation position and the second operation position that correspond to the gesture operation, and displays the candidate throwing route determined according to the current gesture operation in the virtual environment map in real time, so that the user determines, according to the displayed candidate throwing route, whether the current route meets a user throwing requirement.

In some embodiments, similar to the target throwing route, when the candidate throwing route is determined based on the first operation position and the second operation position that correspond to the gesture operation, any line segment passing through the first operation position and the second operation position may be determined as the candidate throwing route. For example, the candidate throwing route may use the first operation position as a route starting point and the second operation position as a route end point.

For a process of determining the candidate throwing route according to the first operation position and the second operation position, reference may be made to the foregoing embodiment, and details are not described in this embodiment again.

Step 506. Determine a target throwing route according to the first operation position and the second operation position at a signal disappearance moment in response to disappearance of the first operation signal and the second operation signal, and display the target throwing route in the virtual environment map.

To improve accuracy of the determined target throwing route, in a possible implementation, when determining that the first operation signal and the second operation signal disappear, the terminal determines that the gesture operation of the user ends, and the target throwing route has been determined, so that the terminal determines the target throwing route according to the first operation position (that is, a final operation position corresponding to the first operation signal in the gesture operation) and the second operation position (that is, a final operation position corresponding to the second operation signal in the gesture operation) at an operation signal disappearance moment.

In some embodiments, when the target throwing route is determined, to enable the user to determine the candidate throwing route indicated by the gesture operation in real time, the terminal changes the candidate throwing route indicated by the gesture operation in the virtual environment map in real time with the change of the gesture operation of the user until the terminal detects that touch and control of the gesture operation ends, that is, the first operation signal and the second operation signal disappear, and the terminal determines the candidate throwing route corresponding to the first operation position and the second operation position at a signal disappearance moment as the target throwing route and displays the target throwing route in the virtual environment map.

In some embodiments, if the user further needs to modify the target throwing route, the user may perform the gesture operation in the virtual environment map again. If the user does not need to modify the target throwing route, the user may close the throwing route setting control, and correspondingly, the airdrop virtual prop is thrown subsequently based on the target throwing route planned by the user.

In some embodiments, after the target throwing route is determined (that is, the operation signals corresponding to the gesture operation disappear), the throwing route setting control is also folded until the throwing route setting control is triggered again by triggering the target prop control.

In some embodiments, when the gesture operation with two operation signals is performed, if the first operation signal or the second operation signal received by the terminal disappears, the first operation signal or the second operation signal cannot be used for determining the target throwing route, the throwing route setting control is not folded, and the user may continuously perform the gesture operation in the throwing route setting control.

Step 507. Determine an actual throwing route corresponding to the target throwing route in a virtual environment based on a position mapping relationship between the virtual environment map and the virtual environment

The target throwing route indicates a route in the virtual environment map in the throwing route setting control, and if the airdrop virtual prop needs to be thrown in an actual virtual environment, the determined target throwing route needs to be mapped to the actual virtual environment. Therefore, in a possible implementation, a position mapping relationship between a position in the virtual environment map and a position in the virtual environment is preset, so that after the target throwing route is determined in the throwing route setting control, an actual throwing route indicated by the target throwing route in the virtual environment may be determined based on the position mapping relationship, to map the target throwing route to the virtual environment.

In one implementation, the method of determining the actual throwing route may include the following steps.

1. Obtain a route starting point and a route end point of the target throwing route in the virtual environment map.

In one implementation, actual position coordinates respectively corresponding to a route starting point and a route end point of the target throwing route in the virtual environment map in the virtual environment may be obtained according to a principle in which a straight line is determined by two points, that is, the actual throwing route corresponding to the target throwing route in the virtual environment may be determined.

2. Determine first position coordinates of the route starting point in the virtual environment and second position coordinates of the route end point in the virtual environment based on the position mapping relationship.

In one implementation, three points may be pre-labelled in the virtual environment, and coordinate positions corresponding to the three pre-labelled points are determined in the virtual environment map, to establish a position mapping relationship between the virtual environment map and the virtual environment. When the actual throwing route is determined, the route starting point and the three points in the virtual environment map may be connected, to determine three direction line segments, then three points may be determined in the virtual environment according to the three direction line segments, and an average value of the three points is obtained, that is, first position coordinates of the route starting point in the virtual environment may be obtained. Similarly, second position coordinates of the route end point in the virtual environment may be obtained.

In some embodiments, a linear or non-linear relationship (a position mapping relationship) between positions in the virtual environment map and the virtual environment may alternatively be determined according to three pre-labelled points, and coordinates corresponding to the route starting point may be directly introduced to the position mapping relationship, that is, first position coordinates corresponding to the route starting point may be obtained. Similarly, second position coordinates corresponding to the route end point may also be obtained.

3. Determine the actual throwing route in the virtual environment according to the first position coordinates and the second position coordinates.

In one implementation, a position of the route starting point in the virtual environment and a position of the route end point in the virtual environment are determined, that is, a position and a length that correspond to the actual throwing route in the virtual environment are determined, so that the actual throwing route of the airdrop virtual prop in the virtual environment is determined.

Step 508. Throw the airdrop virtual prop in the virtual environment according to the actual throwing route.

In one implementation, after the terminal determines an actual throwing starting point and an actual throwing end point (that is, the actual throwing route) in the virtual environment, the terminal may control the virtual carrier prop to appear at the actual throwing starting point in the virtual environment and throw the airdrop virtual prop along the actual throwing route until the airdrop virtual prop reaches the actual throwing end point.

Step 509. Display the airdrop virtual prop thrown along the actual throwing route in the virtual environment.

The terminal controls the virtual carrier prop to throw the airdrop virtual prop along the actual throwing route in the virtual environment, and the airdrop virtual prop thrown along the actual throwing route is displayed in the corresponding virtual environment.

In some embodiments, the terminal may further upload throwing information of the airdrop virtual prop to the server, and the server forwards the throwing information to another terminal.

In another possible application scenario, the server may throw the airdrop virtual prop. After determining the target throwing route, the terminal may determine the actual throwing route corresponding to the target throwing route in the virtual environment based on the position mapping relationship between the virtual environment map and the virtual environment and further report the actual throwing route to the server. The server controls, based on the actual throwing route, the virtual carrier prop to throw the airdrop virtual prop along the actual throwing route in the virtual environment. The corresponding server feeds back throwing information to each terminal, so that the terminal may display, based on the throwing information, the airdrop virtual prop thrown along the actual throwing route in the virtual environment.

In this embodiment, whether the airdrop virtual prop may be used is determined by obtaining a quantity of second virtual objects defeated by a first virtual object, to determine a setting status of the target prop control. In addition, the target throwing route determined by the user in the throwing route setting control is mapped to the virtual environment based on the position mapping relationship, to determine an actual throwing route of the airdrop virtual prop in the virtual environment, so that the airdrop virtual prop is thrown in the virtual environment.

When determining the target throwing route, the user selects and sets the target throwing route in the throwing route setting control. To avoid accidental damage to a virtual object belonging to a same camp when the airdrop virtual prop is thrown in the virtual environment and cause damage to a virtual object in another camp as wider as possible, in a possible implementation, the throwing route setting control may obtain positions of all virtual objects (including virtual objects in a same camp and virtual objects in different camps) in the virtual environment, so that the user performs a gesture operation according to the positions of the virtual objects in the virtual environment map, to determine a suitable target throwing route.

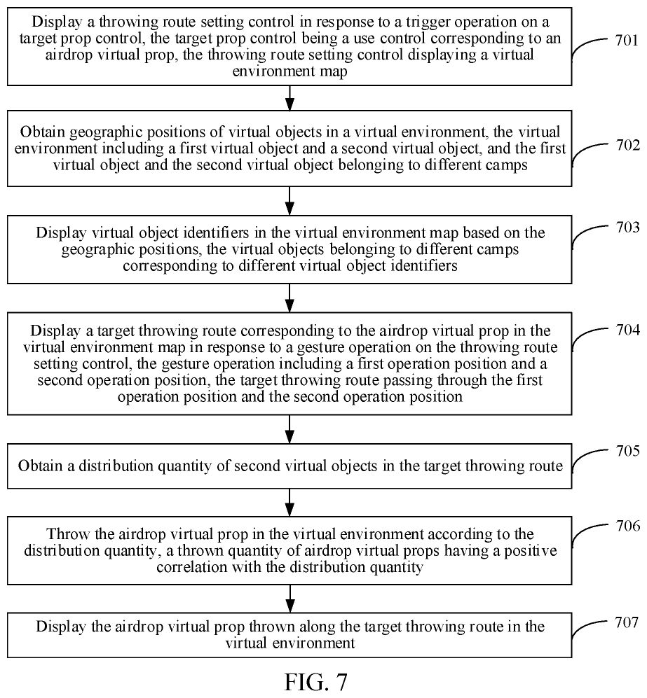

FIG. 7 is a flowchart of a method for controlling a virtual object to use a virtual prop according to another exemplary embodiment of this application. This embodiment is described by using an example in which the method is applied to the first terminal 110 or the second terminal 130 in the implementation environment shown in FIG. 1 or another terminal in the implementation environment. The method includes the following steps:

Step 701. Display a throwing route setting control in response to a trigger operation on a target prop control, the target prop control being a use control corresponding to an airdrop virtual prop, the throwing route setting control displaying a virtual environment map.

For an implementation of this step, reference may be made to the foregoing embodiments, and details are not described again in this embodiment.

Step 702. Obtain geographic positions of the virtual objects in the virtual environment, the virtual environment including a first virtual object and a second virtual object, and the first virtual object and the second virtual object belonging to different camps.

After the throwing route setting control is displayed, to help the user determine the target throwing route corresponding to the airdrop virtual prop based on position distribution of different virtual objects in the virtual environment and to avoid accidental damage to a teammate and cause a higher hit ratio on an enemy, in a possible implementation, the throwing route setting control may scan geographic positions corresponding to the virtual objects in the virtual environment and maps the positions of the virtual objects in the virtual environment to the virtual environment map.

In some embodiments, the second virtual object may be a virtual object controlled by another user or may be a virtual object (a human machine) controlled by a computer.

Step 703. Display virtual object identifiers in the virtual environment map based on the geographic positions, the virtual objects belonging to different camps corresponding to different virtual object identifiers.

Because the virtual environment includes virtual objects in different camps, to help the user distinguish a teammate of the user from an enemy teammate, in a possible implementation, virtual objects belonging to a same camp may be represented by using a same virtual object identifier, virtual objects in different camps are represented by using different virtual object identifiers, and different virtual object identifiers are displayed in the virtual environment map according to the geographic positions of the virtual object identifiers in the virtual environment.

In some embodiments, different virtual object identifiers may adopt different figures of different shapes such as a square shape, a circular shape, or a triangle. Alternatively, different virtual object identifiers may adopt figures of different colors. For example, virtual objects in a first camp adopt red circles, and virtual objects in a second camp adopt yellow circles, or different virtual object identifiers may adopt avatars corresponding to the virtual objects. The virtual object identifier is not limited in this embodiment of this application.

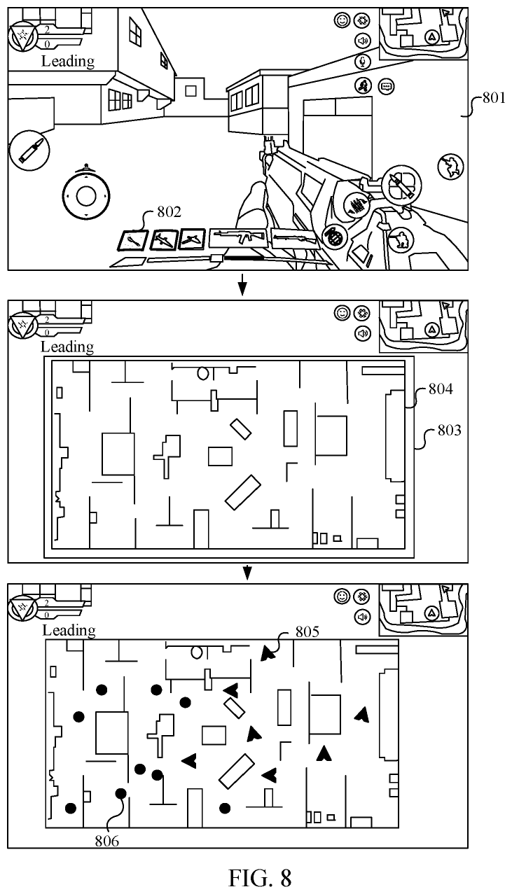

In an exemplary example, FIG. 8 is a schematic diagram of a process of displaying a position of a virtual object according to an exemplary embodiment of this application. After a user clicks/taps a target prop control 802 corresponding to an airdrop virtual prop in a virtual environment picture 801, a route setting control 803 is first displayed in a user interface. In this case, only a virtual environment map 804 (that is, positions of virtual obstacles in a virtual environment) may be displayed in the route setting control 803. Subsequently, the route setting control 803 scans and obtains positions of virtual objects in the virtual environment and displays a virtual object identifier 805 and a virtual object identifier 806 in the virtual environment map 804 based on the positions of the virtual objects in the virtual environment, different virtual object identifiers representing virtual objects belonging to different camps.

In the foregoing embodiments, the virtual object identifier and the virtual environment map are not displayed in the throwing route setting control simultaneously. When receiving a trigger operation on the target prop control, the terminal first displays the virtual environment map in the throwing route setting control, and the terminal obtains geographic positions corresponding to virtual objects in the virtual environment simultaneously and displays corresponding virtual object identifiers in the virtual environment map based on the geographic positions. It can be learned that the virtual object identifier is displayed after the virtual environment map is displayed.

In some embodiments, for a scenario in which the virtual object identifier and the virtual environment map are not displayed simultaneously, to reduce power consumption of the terminal, an object identifier display control may be additionally disposed around the throwing route setting control, and the object identifier display control is used for triggering display of the virtual object identifier in the virtual environment map. In one implementation, after displaying the throwing route setting control, the terminal displays only the virtual environment map in the throwing route setting control. If the user needs to check positions of virtual objects, the user may trigger the object identifier display control. The corresponding terminal receives a trigger operation on the object identifier display control, obtains geographic positions corresponding to the virtual objects in the virtual environment, and further displays the virtual object identifiers in the virtual environment map based on the geographic positions. Otherwise, if the user does not need to display the virtual object identifiers in the virtual environment map, the user may not trigger the object identifier display control, so that an operation logic for the terminal to obtain the geographic positions corresponding to the virtual objects may be reduced, thereby further reducing the power consumption of the terminal.

In some embodiments, the virtual object identifier and the virtual environment map may be simultaneously displayed in the throwing route setting control. In one implementation, after the user clicks/taps the target prop control, the terminal obtains geographic positions corresponding to virtual objects in the virtual environment while displaying the throwing route setting control, to display the virtual object identifiers in the virtual environment map based on the geographic positions corresponding to the virtual objects while displaying the virtual environment map in the throwing route setting control, so that the virtual environment map and the virtual object identifier may be simultaneously displayed in the throwing route setting control without a visual display delay.

Step 704. Display a target throwing route corresponding to the airdrop virtual prop in the virtual environment map in response to a gesture operation on the throwing route setting control, the gesture operation including determining (e.g., dragging) a first operation position and a second operation position on the virtual environment map, the target throwing route passing through the first operation position and the second operation position.

For an implementation of this step, reference may be made to the foregoing embodiments, and details are not described again in this embodiment.

Step 705. Obtain a distribution quantity of second virtual objects in the target throwing route.

The distribution quantity is used for indicating a quantity of second virtual objects in a preset region corresponding throwing points in the target throwing route, and the preset region may be a prop action range of the airdrop virtual prop.

Because positions of the second virtual objects have been identified in the throwing route setting control, when the airdrop virtual prop is correspondingly thrown, to obtain a higher hit ratio for the second virtual object, the airdrop virtual prop may be thrown based on the distribution quantity of second virtual objects.

Step 706. Throw the airdrop virtual prop in the virtual environment according to the distribution quantity, a thrown quantity of airdrop virtual props having a positive correlation with the distribution quantity.

Because the airdrop virtual prop has a specific thrown quantity limitation, to avoid waste of the airdrop virtual prop and generate a higher hit ratio for the second virtual object within the thrown quantity limitation, in a possible implementation, a thrown quantity of airdrop virtual props at the position is determined according to the distribution quantity of second virtual objects in the target throwing route, and the thrown quantity of airdrop virtual props and the distribution quantity are set to a positive correlation, that is, a larger thrown quantity of airdrop virtual props are thrown in a region in which the distribution quantity of second virtual objects is relatively large. Otherwise, a relatively small thrown quantity of airdrop virtual prop may be selected or no airdrop virtual prop is thrown in a region in which the quantity of second virtual object is relatively small or there is no second virtual object.

In an exemplary example, if a quantity of second virtual object at a first point of the target throwing route is four and a quantity of second virtual objects at a second point is seven, five airdrop virtual props may be thrown at the second point, and three airdrop virtual props may be thrown at the first point.

Step 707. Display the airdrop virtual prop thrown along the target throwing route in the virtual environment.

For an implementation of this step, reference may be made to the foregoing embodiments, and details are not described again in this embodiment.

In this embodiment, the virtual object identifiers of the virtual objects may be scanned and displayed in the virtual environment map by using the throwing route setting control, so that the user may determine the target throwing route based on positions of the virtual objects in the virtual environment, to avoid damage to a teammate of the user, thereby improving a hit ratio for an enemy. In addition, when the airdrop virtual prop is thrown in the virtual environment, a quantity of second virtual objects (does not belong to a same camp) and the thrown quantity are set to a positive correlation, so that more airdrop virtual props may be thrown in a region in which the second virtual objects are concentrated, to improve a hit ratio of the airdrop virtual prop. In addition, fewer airdrop virtual props may be thrown in a region with fewer second virtual objects, to avoid a waste of the airdrop virtual prop.

In another possible application scenario, the airdrop virtual prop has a specific throwing attribute such as a preset throwing distance, that is, the airdrop virtual prop can be thrown in the virtual environment only according to the preset throwing distance, or a preset thrown quantity, that is, the airdrop virtual prop cannot be indefinitely thrown, and has a thrown quantity limitation. Therefore, when the airdrop virtual prop is thrown in the virtual environment according to the target throwing route, throwing attribute information corresponding to the airdrop virtual prop also needs to be considered.

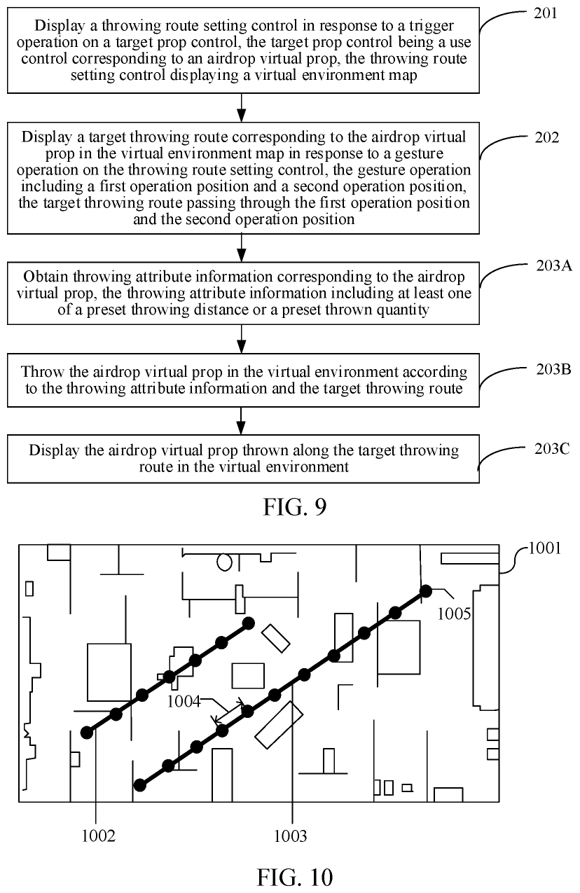

Based on FIG. 2, as shown in FIG. 9, step 203 may include step 203A to step 203C.

Step 203A. Obtain throwing attribute information corresponding to the airdrop virtual prop, the throwing attribute information including at least one of a preset throwing distance or a preset thrown quantity.

The preset throwing distance indicates that the airdrop virtual prop needs to be thrown every a specific distance, that is, a distance between throwing positions corresponding to two adjacent airdrop virtual props is the preset throwing distance. In some embodiments, the preset throwing distance may be set according to a prop action range of the airdrop virtual prop, to avoid a waste of the airdrop virtual prop due to repetition of the prop action range. For example, the preset throwing distance may be 10 m.

In some embodiments, the preset throwing distance may be a distance in an actual virtual environment, and a corresponding preset throwing distance may be 10 m. Alternatively, the preset throwing distance may be a distance in a virtual environment map, and a corresponding preset throwing distance may be 1 cm.

In some embodiments, the preset thrown quantity indicates a total quantity of airdrop virtual props that can be thrown when the airdrop virtual prop is triggered once. For example, the preset thrown quantity may be 40.

In some embodiments, the airdrop virtual prop may have throwing attribute information of both the preset throwing distance and the preset thrown quantity. Correspondingly, during use of the airdrop virtual prop, the airdrop virtual prop needs to be limited by both the throwing attribute information, that is, when throwing the airdrop virtual prop according to the target throwing route, the terminal needs to consider both the preset throwing distance and the preset thrown quantity.

In some embodiments, if the airdrop virtual prop has throwing attribute information of both the preset throwing distance and the preset thrown quantity, during actual use of the airdrop virtual prop, the user may switch to use at least one throwing attribute information based on an actual situation, may choose use only the preset throwing distance to throw the airdrop virtual prop, or may choose to use only the preset thrown quantity to throw the airdrop virtual prop, or may choose the preset throwing distance and the preset thrown quantity to throw the airdrop virtual prop.

In some embodiments, the airdrop virtual prop has only single throwing attribute information. If the airdrop virtual prop has only the throwing attribute information of the preset throwing distance, during use of the airdrop virtual prop, the airdrop virtual prop is thrown according to the preset throwing distance. If the airdrop virtual prop has only the throwing attribute information of the preset thrown quantity, during use of the airdrop virtual prop, the airdrop virtual prop is thrown according to the preset thrown quantity.

In one implementation, after determining the target throwing route, the terminal obtains throwing attribute information corresponding to the airdrop virtual prop, so as to throw the airdrop virtual prop in the virtual environment based on the throwing attribute information.

Step 203B. Throw the airdrop virtual prop in the virtual environment according to the throwing attribute information and the target throwing route.

In one implementation, after obtaining the throwing attribute information corresponding to the airdrop virtual prop, the terminal may throw the airdrop virtual prop in the virtual environment according to the throwing attribute information and the target throwing route.

When the throwing attribute information is the preset throwing distance, a process of throwing the airdrop virtual prop in the virtual environment according to the throwing attribute information and the target throwing route may include the following step 1 and step 2.

1. Determine a target thrown quantity corresponding to the airdrop virtual prop according to the preset throwing distance and a route length corresponding to the target throwing route, the target thrown quantity having a positive correlation with the route length of the target throwing route.

The preset throwing distance may be a distance in the virtual environment map or may be a corresponding actual distance in the virtual environment. When the preset throwing distance is the distance in the virtual environment map, a value of the preset throwing distance may be 1 cm, and when the preset throwing distance is the actual distance in the virtual environment, a value of the preset throwing distance may be 10 m.

When the throwing attribute information of the airdrop virtual prop is the preset throwing distance, a thrown quantity corresponding to each throwing position is the same, and the thrown quantity corresponding to a single throwing position may be preset by the developer. For example, the thrown quantity corresponding to the single throwing position may be three.

Because a throwing distance corresponding to the airdrop virtual prop is fixed, obviously, a longer route length corresponding to the target throwing route indicates a larger thrown quantity corresponding to the airdrop virtual prop required for a current throwing. Otherwise, a shorter route length corresponding to the target throwing route indicates a smaller thrown quantity of airdrop virtual props required for the current throwing, that is, the target thrown quantity has a positive correlation with the route length of the target throwing route.

For example, a relationship among the target thrown quantity, the target throwing route, and the preset throwing distance may be represented as:

N₁=(L/d₁)*n₁

where N₁ represents the target thrown quantity, L represents the route length of the target throwing route, d₁ represents the preset throwing distance, and n₁ represents the thrown quantity corresponding to the single throwing position. L and d₁ need to be corresponding values in a same coordinate system, that is, if d₁ is a preset throwing distance in an actual virtual environment, L is also to be a route length corresponding to a target throwing route in the actual virtual environment. If d₁ is a preset throwing distance in a virtual environment map, L is also to be a route length corresponding to a target throwing route in the virtual environment map.

In an exemplary example, if a length of the target throwing route is 10 cm, and an airdrop virtual prop is thrown once every 1 cm, the airdrop virtual prop needs to be thrown for 10 times. If three airdrop virtual props may be thrown for each throwing, the target thrown quantity corresponding to the airdrop virtual prop is 30. If the length of the target throwing route is 5 cm and an airdrop virtual prop is thrown once every 1 cm, the airdrop virtual prop needs to be thrown for five times, and three airdrop virtual props are thrown for each time, so that the target thrown quantity of airdrop virtual props is 15.

2. Throw the target thrown quantity of the airdrop virtual props in the virtual environment according to the target throwing route.

In one implementation, after the target thrown quantity is determined, the airdrop virtual prop may be thrown every the preset throwing distance in the target throwing route, and the target thrown quantity of the airdrop virtual props are thrown in total.

FIG. 10 is a schematic diagram of throwing an airdrop virtual prop in a virtual environment according to a preset throwing distance and a target throwing route according to an exemplary embodiment of this application. When actual throwing routes shown in a route 1002 and a route 1003 indicated by a target throwing route in a top plane view 1001 (that is, a top view of a virtual environment) are determined, a preset throwing distance is 1004. It can be learned that when an airdrop virtual prop is thrown in an actual throwing route according to the preset throwing distance 1004, because a route length of the route 1003 is greater than a route length of the route 1002, corresponding throwing positions 1005 in the route 1003 are more than throwing positions 1005 in the route 1002, a specific quantity of airdrop virtual props are thrown at each throwing position 1005, and a thrown quantity of airdrop virtual props required for the route 1003 is greater than a thrown quantity of airdrop virtual props required for the route 1002.

When the throwing attribute information is the preset thrown quantity, a process of throwing the airdrop virtual prop in the virtual environment according to the throwing attribute information and the target throwing route may include the following step 3 and step 4.

3. Determine a target throwing distance corresponding to the airdrop virtual prop according to a route length corresponding to the target throwing route and the preset thrown quantity, the target throwing distance having a positive correlation with the route length corresponding to the target throwing route.

The preset thrown quantity may be 40.

To uniformly throw the airdrop virtual prop in the target throwing route and avoid throwing more airdrop virtual props at the beginning of the target throwing route, resulting in fewer remaining airdrop virtual props, which cannot cover the entire target throwing route. Therefore, a target throwing distance of the airdrop virtual prop in the target throwing route needs to be planned according to the preset thrown quantity, so that a throwing range of the airdrop virtual prop may cover the entire target throwing route.

Because the thrown quantity of airdrop virtual props is fixed, if the target throwing route is relatively long, a corresponding throwing distance of the airdrop virtual prop needs to be relatively large to cover the target throwing route in a wider range. Otherwise, if the target throwing route is relatively short, the corresponding throwing distance of the airdrop virtual prop may be shortened, to increase a hit ratio for the virtual object in the target throwing route, that is, the target throwing distance has a positive correlation with the route length corresponding to the target throwing route.

In an exemplary example, a relationship among the preset thrown quantity, the target throwing distance, and the target throwing route may be represented as:

d₂=L/(N₂/n₂)

where d₂ represents the target throwing distance, L represents the route length of the target throwing route, N₂ represents the preset thrown quantity, and n₂ represents the thrown quantity corresponding to the single throwing position. L and d₂ need to be corresponding values in a same coordinate system, that is, if L is a route length corresponding to the target throwing route in the actual virtual environment, d₂ obtained through calculation is also to be a target throwing distance in the actual virtual environment. If L is a route length corresponding to the target throwing route in the virtual environment map, d₂ obtained through calculation is also to be a target throwing distance in the virtual environment map.

In some embodiments, if the target throwing distance determined by the terminal is a distance in the virtual environment map, during actual throwing, the target throwing distance needs to be converted into a target throwing distance in the actual virtual environment, and then throwing is performed in the actual virtual environment according to the target throwing distance.

For example, if the preset thrown quantity is 40, the route length corresponding to the target throwing route in the actual virtual environment is 200 m, and the thrown quantity corresponding to the single throwing position is 4, the target throwing distance is 20 m. If the route length corresponding to the target throwing route in the actual virtual environment is 400 m, the target throwing distance is 40 m.

4. Throw the airdrop virtual prop in the virtual environment according to the target throwing distance.

In one implementation, after the target throwing distance is determined, an airdrop virtual prop may be thrown once every the target throwing distance in the target throwing route until the airdrop virtual prop reaches an end point of the target throwing route.

In an exemplary example, if the target throwing distance is 15 m, an airdrop virtual prop is thrown once every 15 m in a throwing route in the virtual environment.

FIG. 11 is a schematic diagram of throwing an airdrop virtual prop in a virtual environment according to a preset thrown quantity and a target throwing route according to an exemplary embodiment of this application. When actual throwing routes shown in a route 1102 and a route 1103 indicated by a target throwing route in a top plane view 1101 (that is, a top view of a virtual environment) are determined, a preset thrown quantity is 8*5 (that is, there are 8 throwing positions, and 5 airdrop virtual props are thrown at each throwing position). It can be learned that when airdrop virtual props are thrown in the actual throwing routes according to the preset thrown quantity (quantities of throwing positions 1106 are the same), because a route length of the route 1103 is greater than a route length of the route 1102, a corresponding throwing distance 1105 in the route 1103 is greater than a throwing distance 1104 in the route 1102.

In some embodiments, in another optional embodiment, if the airdrop virtual prop has throwing attribute information of both the preset throwing distance and the preset thrown quantity, in an exemplary example, a process of throwing the airdrop virtual prop according to the throwing attribute information and the target throwing route may include the following step 5 and step 6.

5. Determine a target unit thrown quantity corresponding to the airdrop virtual prop according to a route length corresponding to the target throwing route, the preset thrown quantity, and the preset throwing distance, the target unit thrown quantity having a negative correlation with the route length corresponding to the target throwing route.

When a thrown quantity of airdrop virtual props and a throwing distance are fixed, a route length corresponding to the target throwing route affects only a unit thrown quantity corresponding to each throwing position. When the route length corresponding to the target throwing route is longer, a corresponding target unit thrown quantity is smaller, and when the route length corresponding to the target throwing route is shorter, the corresponding target unit thrown quantity is larger. That is, the target unit thrown quantity has a negative correlation with the route length corresponding to the target throwing route.

In an exemplary example, a relationship among the target unit thrown quantity, the preset thrown quantity, the preset throwing distance, and the target throwing route may be represented as:

n₃=N₃/(L/d₃)

where n₃ represents the target unit thrown quantity, that is, the thrown quantity corresponding to the single throwing position, N₃ represents the preset thrown quantity, L represents the route length corresponding to the target throwing route, and d₃ represents the preset throwing distance. L and d₃ need to be corresponding values in a same coordinate system, that is, if d₃ is a preset throwing distance in the actual virtual environment, L is also to be a route length corresponding to a target throwing route in the actual virtual environment. If d₃ is a preset throwing distance in the virtual environment map, L is also to be a route length corresponding to a target throwing route in the virtual environment map.

For example, if the route length corresponding to the target throwing route is 400 m, the preset throwing distance is 40, and the preset thrown quantity is 40, the corresponding target unit thrown quantity is 4. If the route length corresponding to the target throwing route is 200 m, the target unit thrown quantity is 8.

6. Throw the airdrop virtual prop in the virtual environment according to the target unit thrown quantity and the preset throwing distance.

In one implementation, after the target unit thrown quantity is determined, the target unit thrown quantity of airdrop virtual props are thrown every the preset throwing distance in the virtual environment until the preset thrown quantity of airdrop virtual props are thrown.

When the airdrop virtual prop has only single throwing attribute information or the airdrop virtual prop is thrown according to only single throwing attribute information, correspondingly, the airdrop virtual prop corresponds to a fixed unit thrown quantity, and the unit thrown quantity is preset by the developer. If the airdrop virtual prop has two throwing attribute information and the airdrop virtual prop is thrown according to the two throwing attribute information, the airdrop virtual prop corresponds to a dynamic unit thrown quantity, and the unit thrown quantity is determined according to the route length of the target throwing route.

Step 203C. Display the airdrop virtual prop thrown along the target throwing route in the virtual environment.

For an implementation of this step, reference may be made to the foregoing embodiments, and details are not described again in this embodiment.

In this embodiment, when the airdrop virtual prop is thrown according to the target throwing route, throwing attribute information corresponding to the airdrop virtual prop is added as an additional throwing basis, to more accurately throw the airdrop virtual prop in the virtual environment, thereby avoiding a waste of the airdrop virtual prop and improving the hit ratio of the airdrop virtual prop.

The throwing process of the airdrop virtual prop is described in the foregoing embodiments, and this embodiment focuses on a trigger scenario of the airdrop virtual prop.

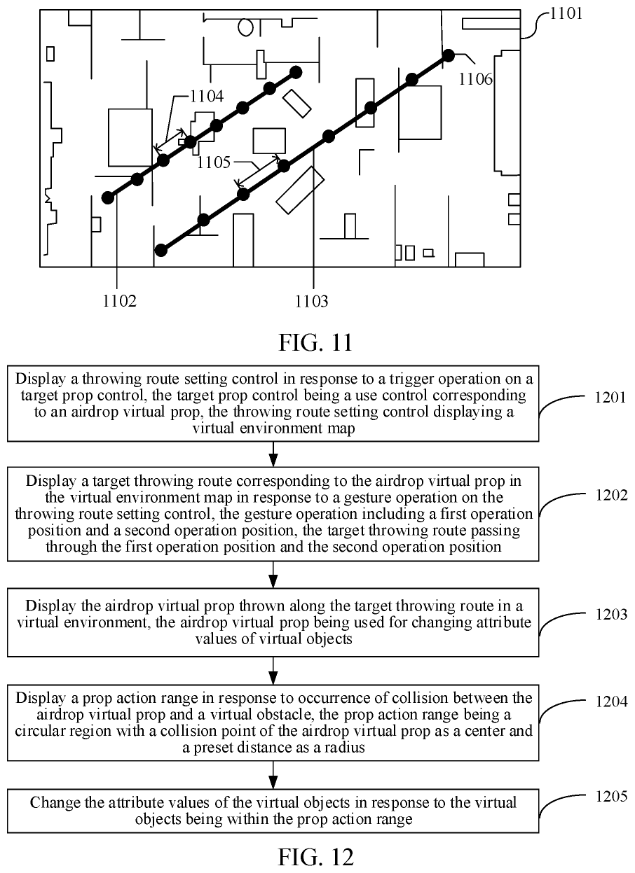

FIG. 12 is a flowchart of a method for controlling a virtual object to use a virtual prop according to another exemplary embodiment of this application. This embodiment is described by using an example in which the method is applied to the first terminal 110 or the second terminal 130 in the implementation environment shown in FIG. 1 or another terminal in the implementation environment. The method includes the following steps:

Step 1201. Display a throwing route setting control in response to a trigger operation on a target prop control, the target prop control being a use control corresponding to an airdrop virtual prop, the throwing route setting control displaying a virtual environment map.

Step 1202. Display a target throwing route corresponding to the airdrop virtual prop in the virtual environment map in response to a gesture operation on the throwing route setting control, the gesture operation including determining (e.g., dragging) a first operation position and a second operation position on the virtual environment map, the target throwing route passing through the first operation position and the second operation position.

Step 1203. Display the airdrop virtual prop thrown along the target throwing route in a virtual environment, the airdrop virtual prop being used for changing attribute values of virtual objects.

For implementations of step 1201 to step 1203, reference may be made to the foregoing embodiments, and details are not described again in this embodiment.

Step 1204. Display a prop action range in response to occurrence of collision between the airdrop virtual prop and a virtual obstacle, the prop action range being a circular region with a collision point of the airdrop virtual prop as a center and a preset distance as a radius.

Because the airdrop virtual prop is thrown over the virtual environment, the airdrop virtual prop may collide with a virtual object or a virtual obstacle during falling. Corresponding trigger mechanisms are set for the two collision situations.

When the airdrop virtual prop collides with the virtual object during falling, an attribute value (a health value) corresponding to the virtual object is directly reduced to 0, but the airdrop virtual prop is not triggered (or explodes), and continues to fall until being in contact with the virtual obstacle.

In one implementation, when colliding with the virtual obstacle during falling, the airdrop virtual prop is triggered (that is, the airdrop virtual prop explodes), and a combustion region (that is, a prop action range) is generated with a collision point as a center. The prop action range is a circular region with the collision point as the center and a preset radius.

In some embodiments, after the airdrop virtual prop explodes, a large amount of smoke is continuously generated to block a line of sight of a virtual object in the region such that a terminal through which a user controls the virtual object displays a dark screen for a predefined duration (e.g., a few seconds).

In some embodiments, the virtual obstacle may be a virtual building, a ground, or the like. This is not limited in this embodiment of this application.

In some embodiments, trailing smoke is also generated during falling of the airdrop virtual prop and is used for blocking the line of sight of the virtual object.

Step 1205. Change the attribute values of the virtual objects in response to the virtual objects being within the prop action range.

In one implementation, the terminal detects a relationship between a nearby virtual object and the prop action region in real time, and when it is determined that the virtual object is located in the prop action region, that is, a health value of the virtual object is reduced.

A manner of determining whether the virtual object is located in the prop action region may be: determining a distance between the virtual object and the collision point, if the distance is less than a preset distance corresponding to the prop action region, determining that the virtual object is located in the prop action region, and reducing a health value corresponding to the virtual object.

In some embodiments, an attribute value reduction value has a negative correlation with the distance between the virtual object and the collision point, that is, when the virtual object is closer to the collision point (the distance is shorter), it indicates that a larger attribute value is reduced, and conversely, it indicates that a smaller attribute value is reduced.

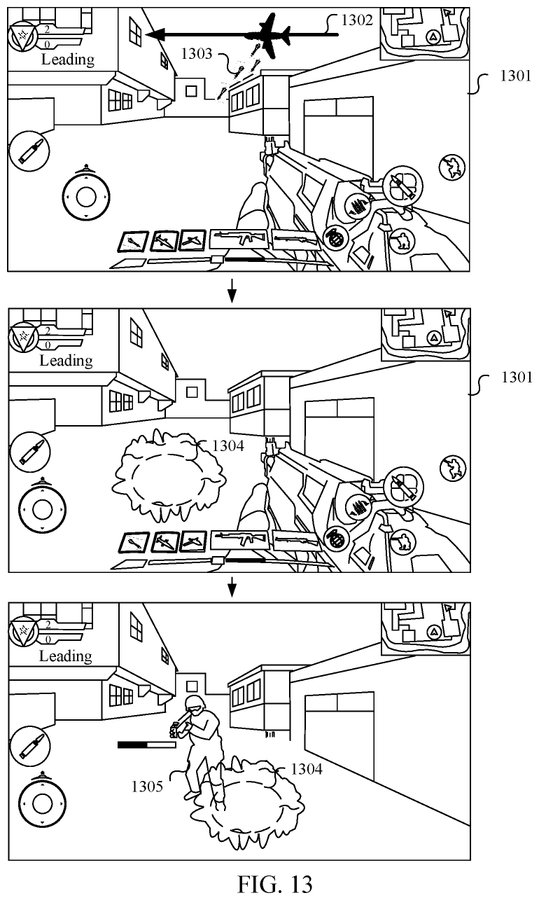

In an exemplary example, FIG. 13 is a schematic diagram of a process of throwing an airdrop virtual prop according to an exemplary embodiment of this application. After a target throwing route is determined, a carrier prop is displayed on a virtual environment picture 1301. The carrier prop throws an airdrop virtual prop 1303 along the target throwing route 1302. When the airdrop virtual prop 1303 collides with a virtual obstacle (for example, landing) during throwing, the airdrop virtual prop 1303 is triggered, a combustion region 1304 is generated, and smoke is generated. After a virtual object 1305 enters the combustion region 1304, a health value of the virtual object 1305 is reduced.

In this embodiment, a collision situation of the airdrop virtual prop during falling, that is, whether the airdrop virtual prop collides with a virtual obstacle, is determined. Only when the airdrop virtual prop collides with the virtual obstacle, a prop action region is triggered and displayed, to reduce an attribute value of a virtual object located in the prop action region.

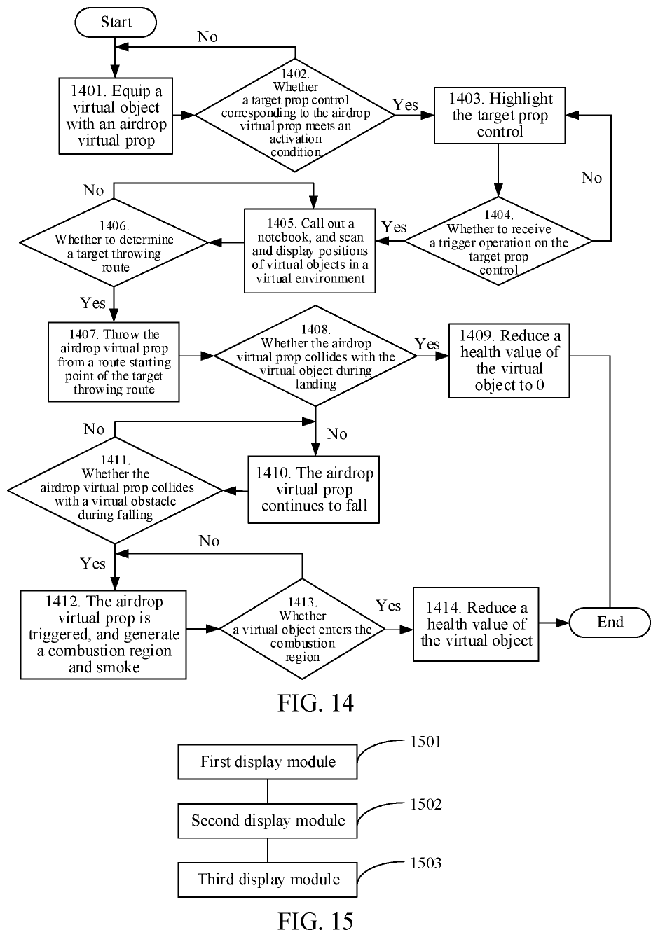

With reference to the foregoing embodiments, in an exemplary embodiment, a process of controlling a virtual object to use a virtual prop is shown in FIG. 14.

Step 1401. Equip a virtual object with an airdrop virtual prop.

A virtual object is equipped with an airdrop virtual prop, and the virtual object may use the airdrop virtual prop in a battle.

Step 1402. Whether a target prop control corresponding to the airdrop virtual prop meets an activation condition.

The activation condition may be a quantity of continuously defeated virtual objects or a score obtained by defeating a virtual object. The activation condition is the use condition of the airdrop virtual prop in the foregoing embodiments.

Step 1403. Highlight the target prop control.

After the airdrop virtual prop meets the activation condition (the use condition), the target prop control corresponding to the airdrop virtual prop is highlighted, and highlighting the prop control means that the target prop control is in an active state.

After the airdrop virtual prop does not meet the activation condition, the target prop control corresponding to the airdrop virtual prop maintains an inactive state.

Step 1404. Whether to receive a trigger operation on the target prop control.

Step 1405. Call out a notebook, and scan and display positions of virtual objects in a virtual environment.

The notebook is the throwing route setting control in the foregoing embodiments. A virtual environment map is displayed in the notebook, and a virtual object identifier is displayed in the virtual environment map based on the scanned geographic positions of the virtual objects.

Step 1406. Whether to determine a target throwing route.

Step 1407. Throw the airdrop virtual prop from a route starting point of the target throwing route.

Step 1408. Whether the airdrop virtual prop collides with the virtual object during landing.

During landing of the airdrop virtual prop, if the airdrop virtual prop directly collides with the virtual object, a health value of the virtual object is reduced to 0, but the airdrop virtual prop is not triggered and continues to fall until colliding with a virtual obstacle and being triggered, and a combustion region and smoke are generated. A health value of a virtual object entering the combustion region is reduced, and the smoke may block a sight range of the virtual object.

In some embodiments, trailing smoke is also generated during falling of the airdrop virtual prop.

Step 1409. Reduce a health value of the virtual object to 0.

Step 1410. The airdrop virtual prop continues to fall.

Step 1411. Whether the airdrop virtual prop collides with a virtual obstacle during falling.

Step 1412. The airdrop virtual prop is triggered, and generate a combustion region and smoke.

The combustion region is the prop action range in the foregoing embodiments.

Step 1413. Whether the virtual object enters the combustion region.

Step 1414. Reduce a health value of a virtual object.

FIG. 15 is a structural block diagram of an apparatus for controlling a virtual object to use a virtual prop according to an exemplary embodiment of this application. The apparatus includes:

a first display module 1501, configured to display a throwing route setting control in response to a trigger operation on a target prop control, the target prop control being a use control corresponding to an airdrop virtual prop, the throwing route setting control displaying a virtual environment map;

a second display module 1502, configured to display a target throwing route corresponding to the airdrop virtual prop in the virtual environment map in response to a gesture operation on the throwing route setting control, the gesture operation including determining (e.g., dragging) a first operation position and a second operation position on the virtual environment map, the target throwing route passing through the first operation position and the second operation position; and

a third display module 1503, configured to display the airdrop virtual prop thrown along the target throwing route in a virtual environment, the airdrop virtual prop being used for changing attribute values of virtual objects.

In some embodiments, the first display module 1503 includes:

a mapping unit, configured to determine an actual throwing route corresponding to the target throwing route in the virtual environment based on a position mapping relationship between the virtual environment map and the virtual environment;

a first throwing unit, configured to throw the airdrop virtual prop in the virtual environment according to the actual throwing route; and

a first display unit, configured to display the airdrop virtual prop thrown along the actual throwing route in the virtual environment.

In some embodiments, the mapping unit is further configured to:

obtain a route starting point and a route end point of the target throwing route in the virtual environment map;

determine first position coordinates of the route starting point in the virtual environment and second position coordinates of the route end point in the virtual environment based on the position mapping relationship; and

determine the actual throwing route in the virtual environment according to the first position coordinates and the second position coordinates.

In some embodiments, the apparatus further includes:

a determining module, configured to determine an actual throwing route corresponding to the target throwing route in the virtual environment based on a position mapping relationship between the virtual environment map and the virtual environment; and

a transmitting module, configured to report the actual throwing route to a server, the server being configured to throw the airdrop virtual prop in the virtual environment according to the actual throwing route.

In some embodiments, the second display module 1502 includes:

a first obtaining unit, configured to obtain, in response to a first operation signal and a second operation signal in the virtual environment map, the first operation position corresponding to the first operation signal and the second operation position corresponding to the second operation signal;

a first determining unit, configured to display a candidate throwing route in the virtual environment map based on the first operation position and the second operation position; and

a second determining unit, configured to determine the target throwing route according to the first operation position and the second operation position at a signal disappearance moment in response to disappearance of the first operation signal and the second operation signal, and display the target throwing route in the virtual environment map.

In some embodiments, the apparatus further includes:

a first obtaining module, configured to obtain geographic positions of the virtual objects in the virtual environment, the virtual environment including a first virtual object and a second virtual object, and the first virtual object and the second virtual object belonging to different camps; and

a fourth display module, configured to display virtual object identifiers in the virtual environment map based on the geographic positions, the virtual objects belonging to different camps corresponding to different virtual object identifiers.

In some embodiments, the first display module 1503 includes:

a second obtaining unit, configured to obtain a distribution quantity of second virtual objects in the target throwing route;

a second throwing unit, configured to throw the airdrop virtual prop in the virtual environment according to the distribution quantity, a thrown quantity of airdrop virtual props having a positive correlation with the distribution quantity; and

a second display unit, configured to display the airdrop virtual prop thrown along the target throwing route in the virtual environment.

In some embodiments, the apparatus further includes:

a second obtaining module, configured to obtain a quantity of second virtual objects defeated by a first virtual object in a target time period, the first virtual object and the second virtual object belonging to different camps;

a first setting module, configured to set the target prop control to an inactive state in response to the quantity being less than a quantity threshold; and

a second setting module, configured to set the target prop control to an active state in response to the quantity being greater than the quantity threshold.

In some embodiments, the third display module 1503 includes:

a third obtaining unit, configured to obtain throwing attribute information corresponding to the airdrop virtual prop, the throwing attribute information including at least one of a preset throwing distance or a preset thrown quantity;

a third throwing unit, configured to throw the airdrop virtual prop in the virtual environment according to the throwing attribute information and the target throwing route;

and

a third display unit, configured to display the airdrop virtual prop thrown along the target throwing route in the virtual environment.

In some embodiments, the throwing attribute information is the preset throwing distance; and

the third throwing unit is further configured to:

determine a target thrown quantity corresponding to the airdrop virtual prop according to the preset throwing distance and a route length corresponding to the target throwing route, the target thrown quantity having a positive correlation with the route length of the target throwing route; and

throw the target thrown quantity of the airdrop virtual props in the virtual environment according to the target throwing route.

In some embodiments, the throwing attribute information is the preset thrown quantity; and

the third throwing unit is further configured to:

determine a target throwing distance corresponding to the airdrop virtual prop according to a route length corresponding to the target throwing route and the preset thrown quantity, the target throwing distance having a positive correlation with the route length corresponding to the target throwing route; and

throw the airdrop virtual prop in the virtual environment according to the target throwing distance.

In some embodiments, the throwing attribute information is the preset thrown quantity and the preset throwing distance; and

the third throwing unit is further configured to:

determine a target unit thrown quantity corresponding to the airdrop virtual prop according to a route length corresponding to the target throwing route, the preset thrown quantity, and the preset throwing distance, the target unit thrown quantity having a negative correlation with the route length corresponding to the target throwing route; and

throw the airdrop virtual prop in the virtual environment according to the target unit thrown quantity and the preset throwing distance.

In some embodiments, the apparatus further includes:

a fifth display module, configured to display a prop action range in response to occurrence of collision between the airdrop virtual prop and a virtual obstacle, the prop action range being a circular region with a collision point of the airdrop virtual prop as a center and a preset distance as a radius; and

a control module, configured to change the attribute values of the virtual objects in response to the virtual objects being within the prop action range.

Based on the foregoing, an airdrop virtual prop is introduced into a virtual prop, and a user may plan a throwing route in a virtual environment map by using a gesture operation, so that the airdrop virtual prop may be thrown along a target throwing route. Compared with the related art in which a virtual prop can be only thrown at a fixed point, in this embodiment of this application, the airdrop virtual prop may be thrown along a specified route. On one hand, a throwing range of the virtual prop is expanded, so that the throwing range of the virtual prop is not easy to be avoided by another virtual object, thereby improving a hit ratio of the virtual prop. On the other hand, when some virtual objects adopt a squatting or remote attack policy, the virtual objects may be attacked remotely in a large range by using the airdrop virtual prop, to improve a hit ratio for the virtual objects, thereby accelerating a battle process, effectively controlling a duration of a single round, and further reducing processing pressure of a server.

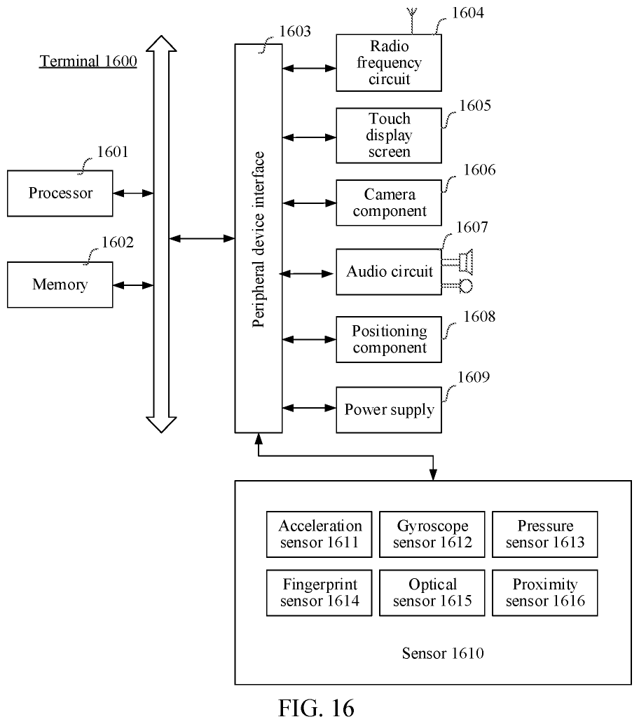

FIG. 16 is a structural block diagram of a terminal 1600 according to an exemplary embodiment of this application. The device 1600 may be a portable mobile terminal such as a smartphone, a tablet computer, an MP3 player, or an MP4 player. The terminal 1600 may be further referred to as other names such as user equipment and a portable terminal.

Generally, the terminal 1600 includes: a processor 1601 and a memory 1602.

The processor 1601 may include one or more processing cores, for example, a 4-core processor or an 8-core processor. The processor 1601 may be implemented by using at least one hardware form of a digital signal processor (DSP), a field-programmable gate array (FPGA), and a programmable logic array (PLA). The processor 1601 may alternatively include a main processor and a coprocessor. The main processor is a processor configured to process data in an active state, also referred to as a central processing unit (CPU). The coprocessor is a low-power processor configured to process data in a standby state. In some embodiments, the processor 1601 may be integrated with a graphics processing unit (GPU). The GPU is configured to render and draw content that needs to be displayed on a display screen. In some embodiments, the processor 1601 may further include an Artificial Intelligence (AI) processor, which is configured to process a machine learning related computing operation.

The memory 1602 may include one or more computer-readable storage media. The computer-readable storage medium may be tangible and non-transient. The memory 1602 may further include a high-speed random access memory and a non-volatile memory, for example, one or more disk storage devices or flash memory devices. In some embodiments, a non-transitory computer-readable storage medium in the memory 1602 is configured to store at least one instruction, the at least one instruction being configured to be executed by the processor 1601 to implement the method provided in the embodiments of this application.

In some embodiments, the terminal 1600 may further optionally include: a peripheral device interface 1603 and at least one peripheral device. Specifically, the peripheral device includes: at least one of a radio frequency (RF) circuit 1604, a touch display screen 1605, a camera component 1606, an audio circuit 1607, a positioning component 1608, and a power supply 1609.

In some embodiments, the terminal 1600 may further include one or more sensors 1610. The one or more sensors 1610 include, but are not limited to, an acceleration sensor 1611, a gyroscope sensor 1612, a pressure sensor 1613, a fingerprint sensor 1614, an optical sensor 1615, and a proximity sensor 1616.

A person skilled in the art may understand that a structure shown in FIG. 16 constitutes no limitation on the terminal 1600, and the terminal may include more or fewer components than those shown in the figure, or some components may be combined, or a different component deployment may be used.

An embodiment of this application further provides a non-transitory computer-readable storage medium, storing at least one instruction, the at least one instruction being loaded and executed by a processor of a terminal and causing the terminal to implement the method for controlling a virtual object to use a virtual prop described in the foregoing embodiments.

According to an aspect of this application, a computer program product or a computer program is provided, the computer program product or the computer program including computer instructions, the computer instructions being stored in a non-transitory computer-readable storage medium. A processor of a terminal reads the computer instructions from the computer-readable storage medium, and executes the computer instructions, to cause the terminal to perform the method for controlling a virtual object to use a virtual prop provided in the optional implementations of the foregoing aspect.

A person skilled in the art is to be aware that in the one or more examples, the functions described in the embodiments of this application may be implemented by using hardware, software, firmware, or any combination thereof. When implemented by using software, the functions can be stored in a computer-readable storage medium or can be used as one or more instructions or code in a computer-readable storage medium for transmission. The computer-readable storage medium includes a computer storage medium and a communication medium, where the communication medium includes any medium that enables a computer program to be transmitted from one place to another. The storage medium may be any available medium accessible to a general-purpose or dedicated computer.

The foregoing descriptions are merely optional embodiments of this application, but are not intended to limit this application. Any modification, equivalent replacement, or improvement made within the spirit and principle of this application shall fall within the protection scope of this application. In this application, the term “unit” or “module” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each unit or module can be implemented using one or more processors (or processors and memory). Likewise, a processor (or processors and memory) can be used to implement one or more modules or units. Moreover, each module or unit can be part of an overall module that includes the functionalities of the module or unit.

What is claimed is:

1. A method for controlling a virtual object to use a virtual prop performed by a terminal, the method comprising:
displaying a throwing route setting control in response to a trigger operation on a target prop control, the target prop control being a use control corresponding to an airdrop virtual prop, the throwing route setting control displaying a virtual environment map;
displaying a target throwing route corresponding to the airdrop virtual prop in the virtual environment map in response to a gesture operation on the throwing route setting control, the gesture operation comprising determining a first operation position and a second operation position on the virtual environment map, the target throwing route passing through the first operation position and the second operation position; and
displaying the airdrop virtual prop thrown along the target throwing route in a virtual environment, the airdrop virtual prop being used for changing attribute values of virtual objects.

2. The method according to claim 1, wherein the displaying the airdrop virtual prop thrown along the target throwing route in a virtual environment comprises:
determining an actual throwing route corresponding to the target throwing route in the virtual environment based on a position mapping relationship between the virtual environment map and the virtual environment;
throwing the airdrop virtual prop in the virtual environment according to the actual throwing route; and
displaying the airdrop virtual prop thrown along the actual throwing route in the virtual environment.

3. The method according to claim 1, wherein the gesture operation further comprises a dragging operation on the virtual environment map.

4. The method according to claim 3, wherein the displaying a target throwing route corresponding to the airdrop virtual prop in the virtual environment map in response to a gesture operation on the throwing route setting control comprises:
determining the first operation position and the second operation position according to a start position of the dragging operation and the current position of the dragging operation; and
displaying the target throwing route according to the first operation position and the second operation position.

5. The method according to claim 1, wherein before displaying a target throwing route corresponding to the airdrop virtual prop in the virtual environment map in response to a gesture operation on the throwing route setting control, the method further comprises:
displaying a candidate throwing route in the virtual environment map based on the first operation position and the second operation position; and
determining the candidate throwing route as the target throwing route when the gesture operation ends.

6. The method according to claim 1, wherein, after the displaying a throwing route setting control in response to a trigger operation on a target prop control, the method further comprises:
obtaining geographic positions of the virtual objects in the virtual environment, the virtual objects including a first virtual object and a second virtual object, and the first virtual object and the second virtual object belonging to different camps; and
displaying virtual object identifiers in the virtual environment map based on the geographic positions, the virtual objects belonging to different camps corresponding to different virtual object identifiers.

7. The method according to claim 1, wherein, before the displaying a throwing route setting control in response to a trigger operation on a target prop control, the method further comprises:
obtaining a quantity of second virtual objects defeated by a first virtual object in a target time period, the first virtual object and the second virtual object belonging to different camps;
setting the target prop control to an inactive state in response to the quantity being less than a quantity threshold; and
setting the target prop control to an active state in response to the quantity being greater than the quantity threshold.

8. The method according to claim 1, wherein the displaying the airdrop virtual prop thrown along the target throwing route in a virtual environment further comprises:
obtaining throwing attribute information corresponding to the airdrop virtual prop, the throwing attribute information comprising at least one of a preset throwing distance or a preset thrown quantity;
throwing the airdrop virtual prop in the virtual environment according to the throwing attribute information and the target throwing route; and
displaying the airdrop virtual prop thrown along the target throwing route in the virtual environment.

9. The method according to claim 1, wherein after the displaying the airdrop virtual prop thrown along the target throwing route in a virtual environment, the method further comprises:
displaying a prop action range in response to occurrence of collision between the airdrop virtual prop and a virtual obstacle; and
changing the attribute values of the virtual objects in response to the virtual objects being within the prop action range.

10. The method according to claim 9, wherein the method further comprises:
generating smoke in the prop action range, wherein the smoke blocks a line of sight of at least one virtual object in the prop action range for a predefined duration.

11. A terminal, comprising a processor and a memory, the memory storing at least one program, the at least one program being loaded and executed by the processor and causing the terminal to implement a method for controlling a virtual object to use a virtual prop, the method including:
displaying a throwing route setting control in response to a trigger operation on a target prop control, the target prop control being a use control corresponding to an airdrop virtual prop, the throwing route setting control displaying a virtual environment map;
displaying a target throwing route corresponding to the airdrop virtual prop in the virtual environment map in response to a gesture operation on the throwing route setting control, the gesture operation comprising determining a first operation position and a second operation position on the virtual environment map, the target throwing route passing through the first operation position and the second operation position; and
displaying the airdrop virtual prop thrown along the target throwing route in a virtual environment, the airdrop virtual prop being used for changing attribute values of virtual objects.

12. The terminal according to claim 11, wherein the displaying the airdrop virtual prop thrown along the target throwing route in a virtual environment comprises:
determining an actual throwing route corresponding to the target throwing route in the virtual environment based on a position mapping relationship between the virtual environment map and the virtual environment;
throwing the airdrop virtual prop in the virtual environment according to the actual throwing route; and
displaying the airdrop virtual prop thrown along the actual throwing route in the virtual environment.

13. The terminal according to claim 11, wherein the gesture operation further comprises a dragging operation on the virtual environment map.

14. The terminal according to claim 13, wherein the displaying a target throwing route corresponding to the airdrop virtual prop in the virtual environment map in response to a gesture operation on the throwing route setting control comprises:
determining the first operation position and the second operation position according to a start position of the dragging operation and the current position of the dragging operation; and
displaying the target throwing route according to the first operation position and the second operation position.

15. The terminal according to claim 11, wherein the method further comprises:
before displaying a target throwing route corresponding to the airdrop virtual prop in the virtual environment map in response to a gesture operation on the throwing route setting control:
displaying a candidate throwing route in the virtual environment map based on the first operation position and the second operation position; and
determining the candidate throwing route as the target throwing route when the gesture operation ends.

16. The terminal according to claim 11, wherein, after the displaying a throwing route setting control in response to a trigger operation on a target prop control, the method further comprises:
obtaining geographic positions of the virtual objects in the virtual environment, the virtual objects including a first virtual object and a second virtual object, and the first virtual object and the second virtual object belonging to different camps; and
displaying virtual object identifiers in the virtual environment map based on the geographic positions, the virtual objects belonging to different camps corresponding to different virtual object identifiers.

17. The terminal according to claim 11, wherein the method further comprises:
before displaying the throwing route setting control:
obtaining a quantity of second virtual objects defeated by a first virtual object in a target time period, the first virtual object and the second virtual object belonging to different camps;
setting the target prop control to an inactive state in response to the quantity being less than a quantity threshold; and
setting the target prop control to an active state in response to the quantity being greater than the quantity threshold.

18. The terminal according to claim 11, wherein the displaying the airdrop virtual prop thrown along the target throwing route in a virtual environment further comprises:
obtaining throwing attribute information corresponding to the airdrop virtual prop, the throwing attribute information comprising at least one of a preset throwing distance or a preset thrown quantity;
throwing the airdrop virtual prop in the virtual environment according to the throwing attribute information and the target throwing route; and
displaying the airdrop virtual prop thrown along the target throwing route in the virtual environment.

19. The terminal according to claim 11, wherein after the displaying the airdrop virtual prop thrown along the target throwing route in a virtual environment, the method further comprises:
displaying a prop action range in response to occurrence of collision between the airdrop virtual prop and a virtual obstacle; and
changing the attribute values of the virtual objects in response to the virtual objects being within the prop action range.

20. A non-transitory computer-readable storage medium, storing at least one program, the at least one program being loaded and executed by a processor of a terminal and causing the terminal to implement a method for controlling a virtual object to use a virtual prop, the method including:
displaying a throwing route setting control in response to a trigger operation on a target prop control, the target prop control being a use control corresponding to an airdrop virtual prop, the throwing route setting control displaying a virtual environment map;
displaying a target throwing route corresponding to the airdrop virtual prop in the virtual environment map in response to a gesture operation on the throwing route setting control, the gesture operation comprising determining a first operation position and a second operation position on the virtual environment map, the target throwing route passing through the first operation position and the second operation position; and
displaying the airdrop virtual prop thrown along the target throwing route in a virtual environment, the airdrop virtual prop being used for changing attribute values of virtual objects.
